(19) United States
(12) Patent Application Publication
(10) Pub. No.: US 2026/0086264 A1
(43) Pub. Date: Mar. 26, 2026

(54) ATTACHMENT TOOL, ATTACHMENT METHOD, AND MULTIPLE-OPTICAL-AXIS PHOTOELECTRIC SENSOR

(71) Applicant: Keyence Corporation, Osaka (JP)

(72) Inventor: Yuga ASANO, Osaka (JP)

(73) Assignee: Keyence Corporation, Osaka (JP)

(21) Appl. No.: 19/294,380

(22) Filed: Aug. 8, 2025

(30) Foreign Application Priority Data
Sep. 24, 2024 (JP) 2024-165339

(51) Int. Cl. G01V 8/20; F16P 3/14

(52) U.S. Cl. CPC G01V 8/20; F16P 3/14

(57) ABSTRACT

The housing of a light curtain includes a side wall portion substantially parallel to the optical axes in sectional view orthogonal to the longitudinal direction. An attachment tool includes a base portion that is attached to the base and receives the housing from a front side, a temporary fixing portion that temporarily fixes the housing to the base portion by elastic support, and a full fixing portion that fully fixes a rotational position of the housing around an axis and an upper-lower position in the longitudinal direction by pressing the housing in a state where the housing is temporarily fixed to the base portion. The base portion includes rotation restricting portions that abut on the side wall portion of the housing to restrict rotation of the housing around the axis within a restricting range in a state where the housing is temporarily fixed to the base portion.

### CROSS-REFERENCE TO RELATED APPLICATIONS

The present application claims foreign priority based on Japanese Patent Application No. 2024-165339, filed Sep. 24, 2024, the contents of which are incorporated herein by reference.

### BACKGROUND OF THE INVENTION

### 1. Technical Field

The invention relates to an attachment tool, an attachment method, and a multiple-optical-axis photoelectric sensor.

### 2. Description of the Related Art

A light curtain is an aspect of a multiple-optical-axis photoelectric sensor. The light curtain detects a person or an object depending on whether or not a plurality of optical axes formed between a light projector and a light receiver are shielded.

The light curtain is fixed to a base (base column) by an attachment tool. As a main function of the attachment tool, there are a function of adjusting the optical axes between the light projector and the light receiver so as to obtain a desired light amount in all the optical axes, and a function of fixing the light curtain so as not to be shifted against an impact or the like.

Note that, in the optical axis adjustment described above, upper-lower movement of the light curtain along a longitudinal direction (axial direction) and rotational movement of the light curtain around the axis are individually performed. As a general work procedure, first, a position of the light curtain in an upper-lower direction with respect to the attachment tool is adjusted, and then the light curtain is temporarily fixed to the attachment tool at the adjusted upper-lower position.

Subsequently, after the rotational position of the light curtain around the axis is adjusted, the light curtain is fully fixed to the attachment tool in the adjusted rotational position.

Incidentally, there is an attachment tool of related art that fixes a housing of a light curtain to the attachment tool by a screw fastening work.

For example, in a multiple-optical-axis photoelectric sensor of JP2003-242868A, an upper-lower position of a light curtain can be adjusted by loosening a first bolt, and the upper-lower position of the light curtain is fixed by tightening the first bolt. In addition, a rotational position of the light curtain around an axis can be adjusted by tightening a second bolt, and the rotational position of the light curtain around the axis is fixed by loosening the second bolt.

In the attachment tool of the related art described above, since it is easy to adopt a metal member, it is easy to secure a fixing force. However, since a plurality of screw tightening works are required, it is difficult to say that workability is high. For example, it is not an easy work to adjust an optical axis of the light curtain while moving back and forth between the adjustment of the upper-lower position and the adjustment of the rotational position with the attachment tool of the related art.

In particular, in the attachment tool of the related art described above, when the second bolt is loosened, the housing of the light curtain can rotate around the axis without limitation. Thus, it can be very difficult for an unskilled worker to adjust the optical axis.

Note that, some attachment tools of the related art have a cylindrical surface slightly smaller in diameter than a columnar light curtain, and temporarily fix the light curtain fitted (inserted) to the cylindrical surface by elastic support. With this configuration, it is easy to temporarily fix the light curtain, and it is also easy to move back and forth between the adjustment of the upper-lower position and the adjustment of the rotational position. However, since it is difficult to adopt a metal member, it is difficult to secure a fixing force. In addition, since the rotational movement around the axis is not limited, it is not easy to adjust the rotational position.

### SUMMARY OF THE INVENTION

In view of the above problems, an object of the invention is to improve easiness of optical axis adjustment when a light curtain is fixed to an attachment tool.

An attachment tool according to the invention is, for example, an attachment tool for attaching, to a base, a housing of a light curtain forming a plurality of optical axes along a longitudinal direction, the housing having a side wall portion substantially parallel to the optical axes in sectional view orthogonal to the longitudinal direction, the attachment tool includes a base portion having a rear surface or a side surface attached to the base and configured to receive the housing from a front side, temporary fixing portions configured to temporarily fix the housing to the base portion by elastic support, and a full fixing portion configured to fully fix a rotational position of the housing around an axis and an upper-lower position in the longitudinal direction by pressing the housing in a state where the housing is temporarily fixed to the base portion. The base portion includes rotation restricting portions that restrict rotation of the housing around the axis to a predetermined restricting range by abutting on the side wall portion of the housing in a state where the housing is temporarily fixed to the base portion.

Note that, other characteristics, elements, steps, advantages, and features will be more apparent from the following detailed description and the accompanying drawings.

According to the invention, in a state where the housing of the light curtain is temporarily fixed to the attachment tool, the rotation angle of the housing around the axis is limited to a predetermined restricting range by the rotation restricting portion. Accordingly, since the user may adjust the optical axis around the axis of the light curtain within the restricting range, the optical axis adjustment can be facilitated.

### BRIEF DESCRIPTION OF THE DRAWINGS

FIG. 1 is a diagram illustrating a schematic configuration of a light curtain;

FIG. 2 is a perspective view illustrating an overall configuration of a light projector;

FIG. 3 is a front view illustrating an overall configuration of the light projector;

FIG. 4 is a perspective view illustrating one end of the light projector;

FIG. 5 is a functional block diagram of the light curtain;

FIG. 6 is a diagram illustrating a first embodiment of the light projector;

FIG. 7 is a diagram illustrating an arrangement example of indicator lamp light sources according to the first embodiment;

FIG. 8 is a diagram illustrating a relationship between a light emission color and an operation mode;

FIG. 9 is a diagram illustrating an arrangement example of indicator lamp light sources according to a second embodiment;

FIG. 10 is a diagram illustrating a display pattern example according to the second embodiment;

FIG. 11 is a diagram illustrating an arrangement example and a display pattern example of indicator lamp light sources according to a third embodiment;

FIG. 12 is a diagram illustrating an arrangement example and a display pattern example of indicator lamp light sources according to a fourth embodiment;

FIG. 13 is a diagram illustrating a relationship between an average light reception amount and a display pattern;

FIG. 14 is a diagram illustrating a relationship between a minimum light reception amount and a display pattern;

FIG. 15 is a diagram illustrating a turned-on image (first example) of a light curtain;

FIG. 16 is a diagram illustrating a turned-on image (second example) of a light curtain;

FIG. 17 is a functional block diagram of a light curtain having a display pattern control function;

FIG. 18 is a diagram illustrating a processing flow of display pattern control;

FIG. 19 is a perspective view illustrating a resin type attachment tool;

FIG. 20 is a four-view diagram illustrating the resin type attachment tool;

FIG. 21 is a diagram illustrating a scene in which a resin type attachment tool is attached to a base;

FIG. 22 is a diagram illustrating a scene in which a housing is attached to the resin type attachment tool;

FIG. 23 is a sectional view illustrating an outer shape of the housing;

FIG. 24 is a sectional view illustrating a scene in which the housing is attached with the front facing;

FIG. 25 is a sectional view illustrating a scene in which rotation of the housing is restricted;

FIG. 26 is a perspective view illustrating a metal type attachment tool;

FIG. 27 is a four-view diagram illustrating the metal type attachment tool;

FIG. 28 is a diagram illustrating a scene in which the metal type attachment tool is attached to the base; and

FIG. 29 is a diagram illustrating a scene in which the housing is attached to the metal type attachment tool.

### DETAILED DESCRIPTION

### <Light Curtain>

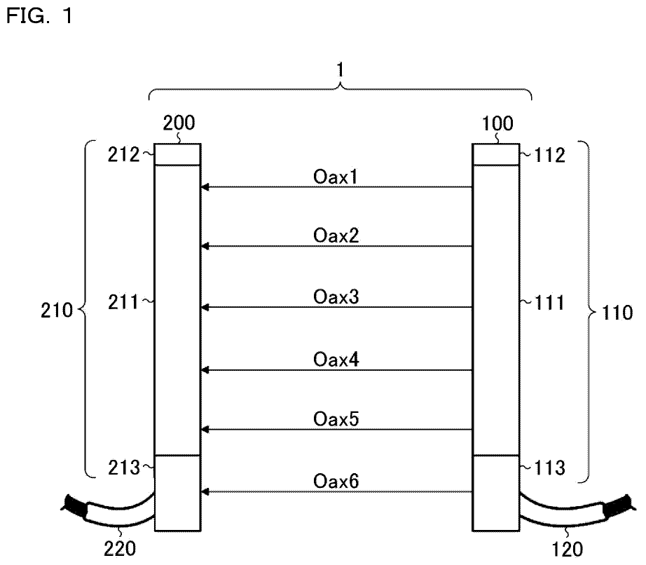

FIG. 1 is a diagram illustrating a schematic configuration of a light curtain. The light curtain 1 of the present configuration example is an aspect of a multiple-optical-axis photoelectric sensor, and generally includes a pair of a light projector 100 and a light receiver 200.

The light curtain 1 detects a person or an object depending on whether or not at least one of a plurality of optical axes (six optical axes Oax1 to Oax6 in this drawing) formed at intervals from each other between the light projector 100 and the light receiver 200 arranged in parallel is shielded. For example, the light curtain 1 is provided at an entrance or the like of a dangerous region where a dangerous source such as a press machine is placed, and can be used as a safety device for detecting intrusion or presence of a worker.

The light projector 100 and the light receiver 200, respectively, include elongated (up to 2 m or more) housings 110 and 210 and cables 120 and 220 connected thereto.

The housing 110 includes a hollow metal case 111 extending in a longitudinal direction, and hollow end caps 112 and 113 (corresponding to end members) connected to both ends of the metal case 111, respectively. Similarly, the housing 210 includes a hollow metal case 211 extending in a longitudinal direction, and hollow end caps 212 and 213 (corresponding to end members) connected to both ends of the metal case 211, respectively. In the present embodiment, the longitudinal direction is a direction substantially parallel to a direction in which the plurality of optical axes formed between the light projector 100 and the light receiver 200 are arranged at intervals.

As described above, when the metal cases 111 and 211 having high rigidity are adopted as the cases of the housings 110 and 210, the elongated housings 110 and 210 are less likely to be deformed. Accordingly, arrangement adjustment (for example, angle adjustment for arranging both housings in parallel) of the light projector 100 and the light receiver 200 becomes relatively easy. Note that, for example, an inexpensive and lightweight aluminum extrusion-molded product may be used as the metal cases 111 and 211. In this case, the metal cases 111 and 211 all have the same section regardless of where the metal cases are cut in an extrusion direction (=longitudinal direction).

Each of the end caps 112, 113, 212, and 213 may be formed by injection molding by using a resin material, or may be formed by die casting by using a metal material such as zinc. Note that, interfaces with the cables 120 and 220 can be mounted on the end caps 113 and 213 on a lower side of this drawing. Thus, the end caps 113 and 213 may be larger than the end caps 112 and 212 on an upper side of this drawing.

### <Light Projector>

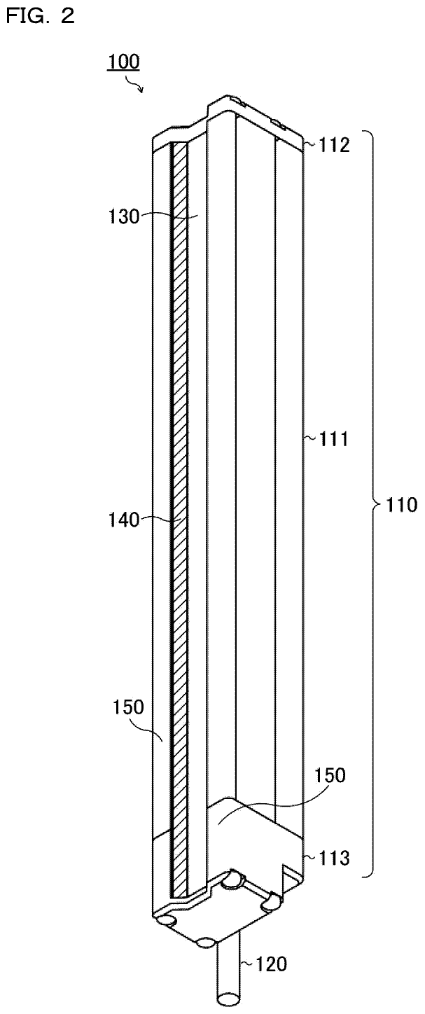

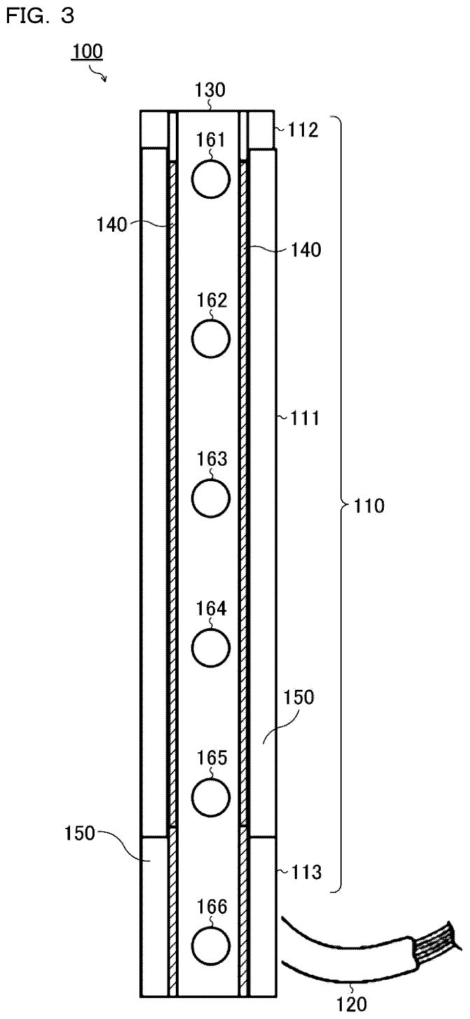

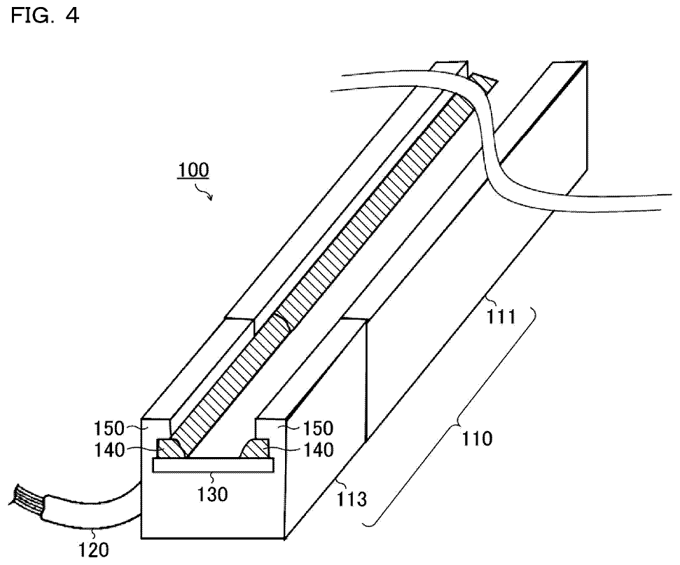

FIGS. 2 and 3 are a perspective view and a front view, respectively, illustrating an overall configuration of the light projector 100. In addition, FIG. 4 is a perspective view illustrating one end of the light projector 100.

As described above, the light projector 100 includes the housing 110 and the cable 120. In addition, the housing 110 includes the metal case 111 and the end caps 112 and 113. Further, the light projector 100 includes a front cover 130, indicator lamps 140, and bumpers 150.

The front cover 130 is an elongated light transmission plate attached to cover a front opening (=detection window) of the housing 110. In the front opening of the housing 110, light projecting elements 161 to 166 for forming the plurality of optical axes Oax1 to Oax6 are arranged at equal intervals along a longitudinal direction. That is, the front cover 130 is attached to the housing 110 so as to cross the plurality of optical axes Oax1 to Oax6. The front cover 130 may be a light-transmissive resin plate (acrylic plate or the like) extrusion-molded or may be a glass plate. The light-transmissive properties of the member used as the front cover 130 in the present embodiment refer to light-transmissive properties to the extent that light beams of the light projecting elements 161 to 166 forming the plurality of optical axes Oax1 to Oax6 are not excessively diffused out of the optical axes and are received by light receiving elements 261 to 266 to be described later with a certain light amount or more. As described above, since the light-transmissive member is used for the front cover 130, a worker can visually recognize the light projecting elements 161 to 166 through the front cover 130.

Note that, the light projecting element (the light projecting element 166 in FIG. 3) corresponding to at least one optical axis among the plurality of optical axes Oax1 to Oax6 may be arranged in the end cap 113. That is, the light projecting elements 161 to 166 may be arranged at equal intervals in the longitudinal direction over the entire region from one end to the other end of the light projector 100. In addition, the cable 120 may extend from a back surface (or side surface) of the end cap 113 instead of extending from a lower surface of the end cap 113. With such a configuration, the light projector 100 can be installed close to an installation surface (floor surface or the like). Accordingly, dead space-less can be realized.

The indicator lamps 140 are controlled to be turned on or off with a light emission color corresponding to, for example, an operation state of the light curtain 1 (an optical-axis detection state, a self-diagnosis result, or the like) or a work instruction regarding putting in and taking out an object. That is, the indicator lamp 140 functions as an operation indicator lamp or a work instruction lamp. Accordingly, the worker can visually recognize the operation state or the work instruction of the light curtain 1 by looking at the indicator lamps 140 of the light curtain 1.

In particular, the indicator lamps 140 are arranged outward from an outer surface of at least one of the front cover 130 and the housing 110 along a longitudinal direction, or are formed in series with the front cover 130 (details of a structure will be described later). With reference to this drawing, the indicator lamps 140 are provided on both sides of the front cover 130. With the indicator lamps 140 arranged or formed in this manner, it is possible to perform highly visible display without impairing the rigidity of the housing 110. More specifically, the indicator lamp 140 is an elongated extrusion-molded product, and is arranged such that the longitudinal direction of the indicator lamp 140 is along the longitudinal direction of the housing 110. Note that, the indicator lamps 140 may be arranged along the longitudinal direction of the housing 110, and a manufacturing method therefor is not limited to extrusion-molding, and a shape of the indicator lamp 140 may not be the elongated shape. For example, a plurality of members functioning as the indicator lamps 140 may be arranged along the longitudinal direction of the housing 110.

In addition, the indicator lamp 140 is a light diffusing member that diffuses light incident from an indicator lamp light source 170 (not illustrated) accommodated inside the housing 110 in various directions. More specifically, the indicator lamp 140 contains a light diffusing body that diffuses light in various directions. In the configuration in which the light diffusing member as the indicator lamp 140 contains the light diffusing body, even in a case where the number of indicator lamp light sources 170 is small with respect to a size of a surface of the indicator lamp 140, since the indicator lamp 140 can be relatively uniformly illuminated, highly visible display can be performed. In the present embodiment, the indicator lamp 140 is milky white because the indicator lamp is made of a transparent resin to which fine particles are added. In a case where a base resin is not transparent but has a specific color, the specific color and milky white are mixed. In a case where the indicator lamp 140 is made of a milky white resin (silicone or the like) in addition to the configuration in which the light diffusing member contains the light diffusing body, it is possible to obtain an action of relatively uniformly illuminating the indicator lamp 140. The light diffusing member as the indicator lamp 140 may be a member that diffuses the light from the indicator lamp light source 170 such that the light can be visually recognized from more directions, or a member that diffuses the light from the indicator lamp light source 170 to such an extent that it is difficult to visually recognize a contour of the indicator lamp light source 170 from an outside of the indicator lamp 140. For example, a light diffusing member having a surface machined to diffuse the light from the indicator lamp light source 170 may be arranged as the indicator lamp 140. For example, emboss machining is known as surface machining for diffusing light. With the configuration in which the light diffusing member having the machined surface is arranged as the indicator lamp 140, in a case where a region in which light is relatively easily diffused and a region in which light is relatively less easily diffused are provided in one member, it is easy to manufacture such a member.

The bumpers 150 protrude outward from a region, of the outer surface of the front cover 130, which crosses the plurality of optical axes Oax1 to Oax6, and are arranged along the longitudinal direction of the housing 110 (details of a structure will be described later).

With reference to this drawing, a pair of bumpers 150 is formed so as to protrude from both sides of the front cover 130. That is, the front cover 130 is disposed in a narrow valley sandwiched between the pair of bumpers 150 (twin bumpers proposed by the applicant of the present application) positioned on both sides thereof and protruding forward. Thus, even though the object collides with a front surface of the light projector 100, the impact thereof is received by the bumpers 150. Accordingly, the front cover 130 is less likely to be damaged. Note that, the bumper 150 may be made of a hard material such as metal.

In addition, a configuration of the light receiver 200 is basically similar to a configuration of the light projector 100. Accordingly, in the description of FIGS. 2 to 4, the configuration of the light receiver 200 can be understood by appropriately reading the light projector 100 and the light projecting elements 161 to 166 with the light receiver 200 and the light receiving elements 261 to 266, respectively, and appropriately replacing reference numerals in other 100 series with reference numerals in 200 series. In addition, the same applies to the following description.

### <Functional Block>

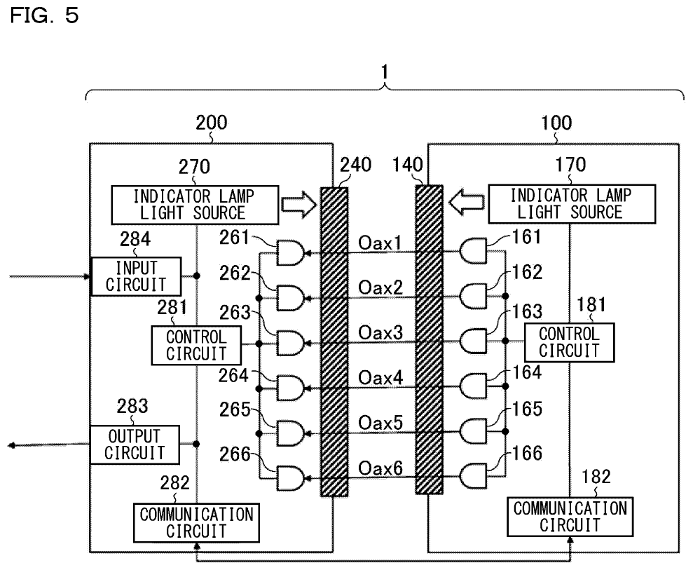

FIG. 5 is a functional block diagram of the light curtain 1. In the light curtain 1 of the present configuration example, the light projector 100 includes the indicator lamps 140, the light projecting elements 161 to 166, the indicator lamp light source 170, a control circuit 181, and a communication circuit 182.

The light projecting elements 161 to 166 are arranged at equal intervals at a predetermined pitch along the longitudinal direction of the light projector 100. The light projecting elements 161 to 166 sequentially project a plurality of light beams for, respectively, forming the plurality of optical axes Oax1 to Oax6 toward the light receiver 200 (in particular, the light receiving elements 261 to 266) in a time division manner based on a light projection control signal input from the control circuit 181. Note that, the light projecting elements 161 to 166 may be, for example, light emitting diodes that emit infrared light beams.

The indicator lamp light source 170 supplies light for display toward the indicator lamps 140 based on a display control signal input from the control circuit 181. The indicator lamp light source 170 may be switchable between a plurality of light emission colors (for example, red, green, and orange) in accordance with the operation state of the light curtain 1, the work instruction, or the like.

Note that, the indicator lamp light source 170 may be pulse-turned on at a timing temporally offset from a light projection or light reception timing of each of the plurality of optical axes Oax1 to Oax6. According to such turned-on or turned-off control, interference with the optical-axis detection by the indicator lamp light source 170 can be suppressed.

The indicator lamp 140 diffuses light incident from the indicator lamp light source 170 in various directions. The worker can visually recognize the operation state of the light curtain 1, the work instruction, or the like by looking at the indicator lamps 140.

In response to an instruction from the light receiver 200, the control circuit 181 generates the light projection control signal so as to sequentially drive the light projecting elements 161 to 166 in a time division manner. In addition, the control circuit 181 generates the display control signal so as to turn on or off the indicator lamp light source 170 in any light emission color. Further, the control circuit 181 exchanges various types of information with the communication circuit 182.

The communication circuit 182 performs wired or wireless communication with the light receiver 200 (in particular, the communication circuit 282). For example, the communication circuit 182 receives an input of information regarding the operation state (an optical-axis detection state, a self-diagnosis result, and the like) of the light curtain 1 from the light receiver 200 and transmits the information to the control circuit 181.

On the other hand, the light receiver 200 includes an indicator lamp 240, light receiving elements 261 to 266, an indicator lamp light source 270, a control circuit 281, a communication circuit 282, an output circuit 283, and an input circuit 284.

The light receiving elements 261 to 266 are arranged at equal intervals at the same pitch as the light projecting elements 161 to 166 along the longitudinal direction of the light receiver 200. The light receiving elements 261 to 266 sequentially receive a plurality of light beams for forming the plurality of optical axes Oax1 to Oax6 in a time division manner based on a light reception control signal input from the control circuit 281. Note that, the light receiving elements 261 to 266 may be, for example, photodiodes or phototransistors that output electric signals corresponding to a light reception amount of infrared light.

The indicator lamp light source 270 supplies light for display toward the indicator lamp 240 based on a display control signal input from the control circuit 281. Similarly to the indicator lamp light source 170, the indicator lamp light source 270 may be switchable between a plurality of light emission colors (for example, red, green, and orange) in accordance with the operation state of the light curtain 1, the work instruction, or the like.

Note that, the indicator lamp light source 270 may be pulse-turned on at a timing temporally offset from the light projection or light reception timing of each of the plurality of optical axes Oax1 to Oax6. According to such turned-on or turned-off control, interference with the optical-axis detection by the indicator lamp light source 270 can be suppressed.

In addition, a case where the indicator lamp light source 270 is continuously turned on will be considered. In this case, it is desirable that a saturation prevention circuit (=a subtraction circuit for a DC component) is provided such that the electric signals output from the light receiving elements 261 to 266 are not saturated even though direct-current light from the indicator lamp light source 270 is received by the light receiving elements 261 to 266.

The indicator lamp 240 diffuses light incident from the indicator lamp light source 270 in various directions. The worker can visually recognize the operation state of the light curtain 1, the work instruction, or the like by looking at the indicator lamp 240.

In addition, since the indicator lamps 140 and 240 are provided on both the light projector 100 and the light receiver 200, respectively, highly visible display can be performed.

The control circuit 281 generates the light reception control signal so as to sequentially enable the light receiving elements 261 to 266 in a time division manner in synchronization with a drive timing of each of the light projecting elements 161 to 166. In addition, the control circuit 281 generates the display control signal so as to turn on or off the indicator lamp light source 270 in any light emission color. Further, the control circuit 281 exchanges various types of information with the communication circuit 282, the output circuit 283, and the input circuit 284.

In addition, the control circuit 281 monitors a light incident state or a light shielding state of each of the plurality of optical axes Oax1 to Oax6. For example, the control circuit 281 may output an operation permission signal (ON signal) when all of the plurality of optical axes Oax1 to Oax6 are in the light incident state. On the other hand, the control circuit 281 may output an operation non-permission signal (OFF signal) when at least one of the plurality of optical axes Oax1 to Oax6 is in the light shielding state.

Further, the control circuit 281 may have a function of self-diagnosing whether or not the light incident state or light shielding state of each of the plurality of optical axes Oax1 to Oax6 can be correctly monitored. Note that, as the self-diagnosis method, for example, the control circuit 281 and the output circuit 283 (for example, an output signal switching device [OSSD] output) may be multiplexed, and matching or mismatching of multiplexed signals may be determined.

For example, when the multiplexed signals are matched with each other, OK diagnosis (=a diagnosis result indicating that the state can be correctly monitored) is made. On the other hand, when the multiplexed signals are not matched with each other, NG diagnosis (=a diagnosis result indicating that the state cannot be correctly monitored) is made. Note that, in a case where the NG diagnosis is made, the operation non-permission signal (OFF signal) may be output regardless of the light incident state of each of the plurality of optical axes Oax1 to Oax6.

Note that, information that can be used for safety control is safety information, and general information that cannot be used for safety control is unsafety information. For example, the OSSD output is one piece of safety information. The signal used for the turned-on or turned-off control of each of the indicator lamp light sources 170 and 270 may be a signal indicating the safety information or a signal indicating the unsafety information.

The communication circuit 282 performs wired or wireless communication with the light projector 100 (in particular, the communication circuit 182). For example, the communication circuit 282 receives an input of the information regarding the operation state (an optical-axis detection state, a self-diagnosis result, and the like) of the light curtain 1 from the control circuit 281 and transmits the information to the light projector 100.

The output circuit 283 performs wired or wireless communication with an external machine (for example, a safety controller). For example, the output circuit 283 receives an input of the operation state (an optical-axis detection state, a self-diagnosis result, or the like) of the light curtain 1 from the control circuit 281 and transmits the information to an external machine.

The input circuit 284 performs wired or wireless communication with an external machine (for example, a safety controller). For example, the input circuit 284 receives an input of a work instruction regarding putting in and taking out an object from an external machine and transmits the work instruction to the control circuit 281.

### First Embodiment

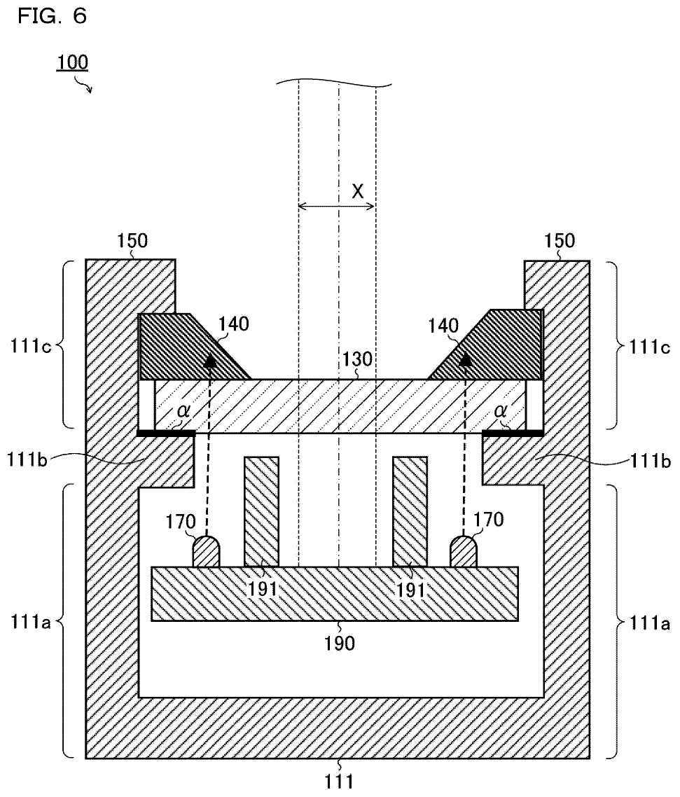

FIG. 6 is a diagram (=a schematic sectional view when a metal case 111 of a light projector 100 is cut at any position in a longitudinal direction) illustrating a first embodiment of the light projector 100. The light projector 100 of the present embodiment includes a housing 110 (only a metal case 111 is depicted in this drawing), a front cover 130, indicator lamps 140, bumpers 150, an indicator lamp light source 170, a substrate 190, and a light shielding plate 191.

The metal case 111 is an extrusion-molded product extending in the longitudinal direction of the light projector 100. With reference to this drawing, the metal case 111 includes a body 111a, a pair of first protruding stripes 111b, and a pair of second protruding stripes 111c.

The body 111a is a hollow member having a U-shaped section with an opening on an upper side of the drawing (=a front side of the light projector 100). The indicator lamp light source 170, the substrate 190, and the light shielding plate 191 are accommodated in an internal space of the body 111a.

The pair of first protruding stripes 111b protrudes from inner side surfaces of left side wall and right side wall of the body 111a toward an inside of the opening. That is, the pair of first protruding stripes 111b is arranged so as to face each other with a predetermined interval, sandwiching an optical-axis crossing region X (=a region crossing a plurality of optical axes Oax1 to Oax6). Note that, the pair of first protruding stripes 111b functions as cover attachment portions for supporting the front cover 130. As described above, a light-transmissive member is used for the front cover 130 as long as the light-transmissive member is provided at least in the optical-axis crossing region X and the optical axes Oax1 to Oax6 are not hindered. For example, in the present embodiment, a portion coming into contact with the pair of first protruding stripes 111b does not necessarily have light-transmissive properties.

The pair of second protruding stripes 111c extends further upward in the drawing from upper ends of the left side wall and the right side wall of the body 111a. In addition, each of the pair of second protruding stripes 111c has a distal end bent toward the inside of the opening. Note that, the pair of second protruding stripes 111c functions as the bumpers 150 for protecting the front cover 130. That is, in the present embodiment, the bumpers 150 described above are formed from the metal case 111. Accordingly, the fastness of the light projector 100 can be enhanced.

The front cover 130 is supported (suspended) at both ends across the pair of first protruding stripes 111b. The front cover 130 causes light beams forming the plurality of optical axes Oax1 to Oax6 to pass in the optical-axis crossing region X. Processing of improving liquid resistance is performed between the front cover 130 and the pair of first protruding stripes 111b (see a thick line a). For example, processing of arranging a packing and bonding with a liquid-resistant adhesive is performed. As described later, since bonding properties between the front cover 130 and the first protruding stripes 111b are enhanced by the indicator lamps 140, liquid resistance is further improved.

The indicator lamps 140 are arranged on both sides of the front cover 130 to be adjacent to the bumpers 150. With reference to this drawing, the indicator lamps 140 are arranged along the longitudinal direction of the light projector 100 in regions sandwiched between the first protruding stripes 111b and the distal ends (bent portions) of the second protruding stripes 111c, that is, in regions sandwiched between the bumpers 150 and the front cover 130.

Note that, the indicator lamp 140 diffuses light incident from the indicator lamp light source 170 via the front cover 130 in various directions. For example, the indicator lamp 140 may have a taper for refracting and diffusing the light incident from the indicator lamp light source 170 toward the inside of the opening.

With the indicator lamps 140 arranged in this manner, it is easy to see even from a side of the light projector 100. Accordingly, in the small-sized (small-diameter) light curtain 1 using the metal case 111, it is possible to perform highly visible display without impairing the rigidity of the housing 110. In particular, in a case where the pair of bumpers 150 is provided so as to protrude from both sides of the front cover 130, an effect of improving the visibility by the above arrangement can be more remarkable.

In addition, in the light projector 100 of the present embodiment, the indicator lamps 140 also function as pressing members for pressing and fixing the front cover 130 downward (=in a direction toward the first protruding stripes 111b). Accordingly, since the bonding properties between the front cover 130 and the first protruding stripe 111b are enhanced, liquid resistance can be improved by preventing liquid from entering the inside of the metal case 111. Note that, in order for the indicator lamps 140 to have the function as the pressing members, it is desirable that the indicator lamps 140 have appropriate elasticity.

The indicator lamp light source 170 is mounted on a main surface (=a surface facing the front cover 130) of the substrate 190. The indicator lamp light source 170 supplies light for display toward the indicator lamps 140 via the front cover 130. With reference to this drawing, the light emitted from the indicator lamp light source 170 passes between the pair of first protruding stripes 111b without being shielded by the pair of first protruding stripes 111b, and is supplied to the indicator lamps 140 via the front cover 130.

Note that, the number of indicator lamp light sources 170 is not limited. For example, a plurality of indicator lamp light sources 170 may be intermittently arranged or may be formed in series along the longitudinal direction of the light projector 100.

In addition, the indicator lamp light source 170 may include a lens for controlling a direction of the emitted light. For example, a lens that is optically designed so as to reduce a spread angle of light in a left-right direction in this drawing and to increase the spread angle of light in a depth direction in this drawing may be provided. According to such a lens, it is possible to reduce the number of indicator lamp light sources 170 while suppressing interference with the plurality of optical axes Oax1 to Oax6.

Note that, a type of the lens may be a point symmetrical lens (single lens arrangement) or a cylindrical lens (series arrangement by extrusion-molded product).

The light shielding plate 191 is provided between the indicator lamp light source 170 and the optical-axis crossing region X. Accordingly, since the light from the indicator lamp light source 170 toward the optical-axis crossing region X is shielded, the light emitted from the indicator lamp light source 170 is less likely to interfere with the plurality of optical axes Oax1 to Oax6.

In addition, a case where the optical axes Oax1 to Oax6 are formed by infrared light, and visible light (red light, green light, orange light, or the like) is emitted from the indicator lamp light source 170 is considered. In this case, a filter that transmits infrared light and shields visible light may be provided in the light receiver 200. In particular, in a case where the indicator lamps 240 are provided in the light receiver 200, a filter that transmits infrared light and shields visible light may be arranged so as not to shield the display of the indicator lamps 240. Filters may be provided in the light receiving elements 261 to 266, or a filter may be provided in a lens that guides light to the light receiving elements 261 to 266.

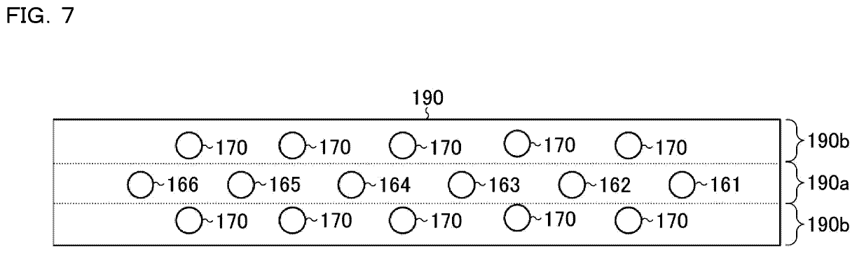

FIG. 7 is a diagram illustrating an arrangement example of the indicator lamp light sources 170 according to the first embodiment. As illustrated in this drawing, the light projecting elements 161 to 166 may be arranged at equal intervals along a longitudinal direction of the substrate 190 in a central region 190a of the substrate 190. On the other hand, the indicator lamp light sources 170 may be arranged at equal intervals along the longitudinal direction of the substrate 190 in an end region 190b of the substrate 190.

In particular, the light projecting elements 161 to 166 and the indicator lamp light sources 170 may be arranged such that positions in the longitudinal direction of the substrate 190 are shifted from each other (staggered). According to such an arrangement example, mutual interference between the light projecting elements 161 to 166 and the indicator lamp light sources 170 is suppressed.

Note that, the number and arrangement of the indicator lamp light sources 170 are not limited to the arrangement example in this drawing. For example, the number of indicator lamp light sources 170 can be reduced such that the light beams supplied to the indicator lamps 140 have some unevenness.

### <Display Content>

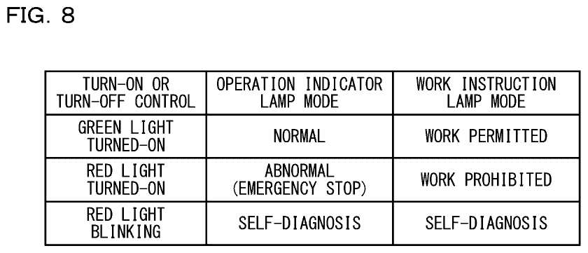

FIG. 8 is a diagram illustrating a relationship between a light emission color of the indicator lamp 140 and an operation mode. As illustrated in this drawing, the indicator lamp 140 can be switched to any one of an operation indicator lamp mode and a work instruction lamp mode. For example, a control signal for switching the operation mode of the indicator lamp 140 may be a 2-bit (four-value) digital signal input to the input circuit 284.

First, a case where the indicator lamp 140 is set to the operation indicator lamp mode will be described. When the operation indicator lamp mode is set, the indicator lamp 140 is controlled to be turned on or off with a light emission color corresponding to the operation state of the light curtain 1.

With reference to this drawing, for example, when the light curtain 1 is in a normal state (for example, a state where all of the plurality of optical axes Oax1 to Oax6 are not shielded), the indicator lamp 140 is turned on in green. On the other hand, when the light curtain 1 is in an abnormal state (for example, an emergency stop state where at least one of the plurality of optical axes Oax1 to Oax6 is shielded), the indicator lamp 140 is turned on in red. In addition, when the light curtain 1 is in an alarm notification state (for example, an NG diagnosis state by a self-diagnosis function), the indicator lamp 140 blinks in red.

Next, a case where the indicator lamp 140 is set to the work instruction lamp mode will be described. When the work instruction lamp mode is set, the indicator lamp 140 is controlled to be turned on or off with a light emission color corresponding to the work instruction signal received by the input circuit 284.

With reference to this drawing, for example, when the work instruction signal indicates a “work permitted state”, the indicator lamp 140 is turned on in green. On the other hand, when the work instruction signal indicates a “work prohibited state”, the indicator lamp 140 is turned on in red. In addition, when the work instruction signal indicates “self-diagnosis”, the indicator lamp 140 blinks in red. Note that, in the work instruction lamp mode, the indicator lamp 140 may be turned on in orange. A method for using a turned-on state may vary depending on a user.

In addition, in a case where the light curtain 1 is used under an environment where light emission of the indicator lamp 140 is not desirable, the indicator lamp 140 can be constantly turned off.

### <Consideration on Reduction in Optical Axis Light Reception Amount>

As described above, the light curtain includes two of the light projector and the light receiver, and the plurality of light projecting elements and the plurality of light receiving elements are arranged in an axial direction. When the light curtain is used, the light projector and the light receiver are arranged in parallel, and an angle is adjusted such that a light reception amount can be obtained by all the elements. The farther a distance between the light projector and the light receiver is, the more difficult it is to understand whether an orientation is correct, and the more difficult it is to see the display. Thus, it is difficult to adjust the angle.

The light curtain may be used in harsh environments such as dirt or bumps. Therefore, in order to protect a front cover of a detection unit, there is a product having a bumper shape protruding from the front cover. However, it is difficult to prevent adhesion of dirt to the front cover. When the adhesion of dirt accumulates and the light receiving elements cannot receive light with a sufficient light amount, the optical axis is in the light shielding state, and there is a possibility that activation of the device is stopped due to a safety output from the light curtain. Thus, maintenance for cleaning a glass surface of the front cover is required before a detection result of the optical axis is influenced.

In an environment where dirt adheres, it is required to install the light curtain so as to secure an optical axis light reception amount with a margin against a decrease in an optical axis light reception amount due to dirt (=a light reception amount every optical axis serving as a criterion for determining whether or not the optical axis is in the light shielding state). In addition, it is also required to perform maintenance before the optical axis becomes the light shielding state by confirming a decrease in the optical axis light reception amount over time.

In response to the above requirements, there is a model capable of confirming the optical axis light reception amount by the body of the light curtain. For example, in an existing model, a magnitude of the optical axis light reception amount is expressed by the number of a plurality of turned-on light emitting diodes [LEDs] or numeral display of seven segments. However, these displays are small and difficult to see from a long distance. Thus, it may be difficult to confirm the display at the time of adjusting the installation of the light curtain. In addition, even during operation of the light curtain, it is difficult to notice a decrease in the optical axis light reception amount unless the above-described small display is confirmed in consideration.

On the other hand, large-sized indicator lamps 140 and 240 are provided in the light curtain 1 described in the present specification so far such that an activation state of the light curtain 1 is easily visually recognized while achieving both size reduction and high visibility.

In view of the above consideration, hereinafter, a novel embodiment in which display interlocked with the optical axis light reception amount can be performed by the indicator lamps 140 and 240 with high visibility is proposed.

### Second Embodiment

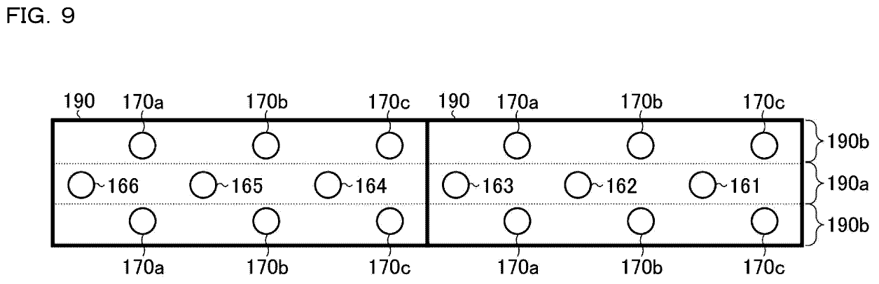

FIG. 9 is a diagram illustrating an arrangement example of an indicator lamp light source according to a second embodiment. In the present embodiment, a plurality of (two in this drawing) substrates 190 having an identical structure are cascade-connected along a longitudinal direction. With such a configuration, a light curtain 1 can be easily elongated by simply increasing the number of cascade connections of the substrates 190.

In this drawing illustrating a light projector 100, light projecting elements 161 to 166 may be arranged at equal intervals along the longitudinal direction of the substrate 190 in a central region 190a of the substrate 190, similarly to FIG. 7 described above. With reference to this drawing, the light projecting elements 161 to 163 are arranged on the substrate 190 on a right side of the drawing in an illustrated order from a right side to a left side of the drawing. On the other hand, on the substrate 190 on a left side of the drawing, the light projecting elements 164 to 166 are arranged in an illustrated order from a right side to a left side of the drawing. Note that, in a case where a configuration of a light receiver 200 is understood, each of the light projecting elements 161 to 166 may be read as light receiving elements 261 to 266.

On the other hand, the indicator lamp light sources 170 may be arranged at equal intervals along the longitudinal direction of the substrate 190 in an end region 190b of the substrate 190. In particular, the indicator lamp light sources 170 can be distinguished as indicator lamp light sources 170a, 170b, and 170c depending on a difference in each control system. With reference to this drawing, the indicator lamp light sources 170a, 170b, and 170c are arranged on two substrates 190 in an illustrated order from a left side to a right side of the drawing. Note that, although not illustrated in this drawing, the light curtain 1 includes an OSSD indicator lamp of which a display aspect changes in accordance with an OSSD output, separately from the indicator lamp light source 170. Thus, the display aspect of the indicator lamp light source 170 changes so as to indicate light reception states of the light receiving elements 261 to 266.

As described above, the light projecting elements 161 to 163 (or 164 to 166) and the indicator lamp light sources 170a, 170b, and 170c are arrayed on the common substrate 190, as one unit. In particular, the indicator lamp light sources 170a, 170b, and 170c are unitized as a set of three light sources.

Note that, as a modification, the light projecting elements 161 to 163 (or 164 to 166) and the indicator lamp light sources 170a, 170b, and 170c may be individual units. That is, a unit in which the light projecting elements 161 to 163 (or 164 to 166) are arrayed and a unit in which the indicator lamp light sources 170a, 170b, and 170c are arranged may be independent from each other.

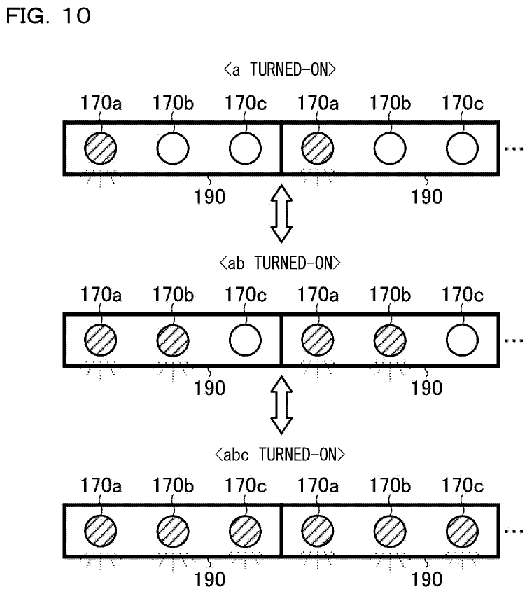

FIG. 10 is a diagram illustrating a display pattern example according to the second embodiment. In an upper part of this drawing, “a turned-on state” is depicted. In this “a turned-on state”, the indicator lamp light sources 170a are turned on, and both of the indicator lamp light sources 170b and 170c are turned off. Accordingly, a display pattern in which “turning on one, turning off two” is repeated from a left side to a right side of the drawing is obtained.

In a middle part of this drawing, an “ab turned-on state” is depicted. In this “ab turned-on state”, both the indicator lamp light sources 170a and 170b are turned on, and the indicator lamp light source 170c is turned off. Accordingly, a display pattern in which “turning on two, turning off one” is repeated from a left side to a right side of the drawing is obtained.

In a lower part of this drawing, an “abc turned-on state” is depicted. In this “abc turned-on state”, all of the indicator lamp light sources 170a, 170b, and 170c are turned on.

As described above, in a display pattern example according to the present embodiment, the indicator lamp light sources 170a, 170b, and 170c are appropriately intermittently turned on. Accordingly, the display pattern is switched to any one of the above three patterns in accordance with the optical axis light reception amount, and thus, the optical axis light reception amount can be discriminated only by looking at the large-sized indicator lamps 140 and 240. As a result, the light curtain 1 that is easily adjusted at the time of initial setting and has high maintainability is provided.

### Third Embodiment

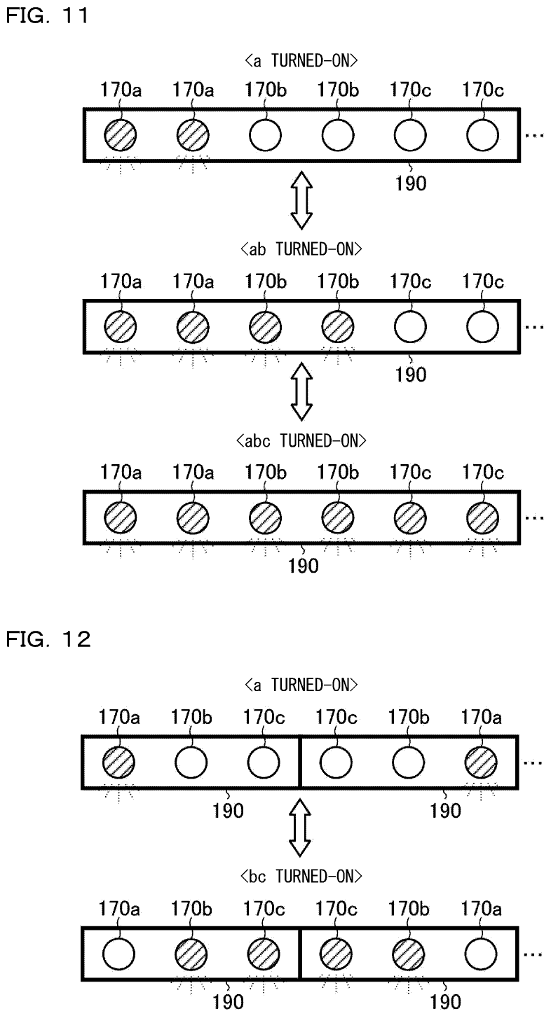

FIG. 11 is a diagram illustrating an arrangement example and a display pattern example of indicator lamp light sources according to a third embodiment. In the present embodiment, two indicator lamp light sources 170a, two indicator lamp light sources 170b, and two indicator lamp light sources 170c are arrayed on a common substrate 190, as one unit. That is, the indicator lamp light sources 170a, 170b, and 170c are unitized as a set of six light sources.

With reference to this drawing, two indicator lamp light sources 170a, two indicator lamp light sources 170b, and two indicator lamp light sources 170c are arranged on the substrate 190 in an illustrated order from a left side to a right side of the drawing.

In an upper part of this drawing, “a turned-on state” is depicted. In this “a turned-on state”, the indicator lamp light sources 170a are turned on, and both of the indicator lamp light sources 170b and 170c are turned off. Accordingly, a display pattern in which “turning on two, turning off four” is repeated from a left side to a right side of the drawing is obtained.

In a middle part of this drawing, an “ab turned-on state” is depicted. In this “ab turned-on state”, both the indicator lamp light sources 170a and 170b are turned on, and the indicator lamp light sources 170c are turned off. Accordingly, a display pattern in which “turning on four, turning off two” is repeated from the left side to the right side of the paper surface is obtained.

In a lower part of this drawing, an “abc turned-on state” is depicted. In this “abc turned-on state”, all of the indicator lamp light sources 170a, 170b, and 170c are turned on.

Note that, in the second embodiment (FIG. 10) described above, the number of indicator lamp light sources 170a, 170b, and 170c in a non-turned-on state (turned-off state) is increased or decreased by one such as 2, 1, and 0 every display pattern.

On the other hand, in the arrangement example of the indicator lamp light sources and the display pattern example according to the present embodiment, the number of indicator lamp light sources 170a, 170b, and 170c in the non-turned-on state is increased or decreased by two such as 4, 2, and 0 every display pattern. Accordingly, as compared with the second embodiment (FIG. 10) described above, a difference in a distance between the light sources to be intermittently turned on becomes large. As a result, the switching of the display pattern (and the change in the optical axis light reception amount) is easily recognized through the light diffusing body.

### Fourth Embodiment

FIG. 12 is a diagram illustrating an arrangement example and a display pattern example of indicator lamp light sources according to a fourth embodiment. Similarly to the second embodiment (FIG. 10) described above, in the present embodiment, indicator lamp light sources 170a, 170b, and 170c are unitized as a set of three. However, an array order of the indicator lamp light sources 170a, 170b, and 170c differs every substrate 190.

With reference to this drawing, the indicator lamp light sources 170a, 170b, and 170c are arranged on the substrate 190 on a left side of the drawing in an illustrated order from a left side to a right side of this drawing. On the other hand, the indicator lamp light sources 170a, 170b, and 170c are arranged in an illustrated order on the substrate 190 on a right side of this drawing from a right side to a left side of this drawing.

In an upper part of this drawing, “a turned-on state” is depicted. In this “a turned-on state”, the indicator lamp light sources 170a are turned on, and both of the indicator lamp light sources 170b and 170c are turned off. Accordingly, a display pattern in which “turning on one, turning off four, turning on one” is repeated from a left side to a right side of the drawing is obtained.

In a lower part of this drawing, an “bc turned-on state” is depicted. In this “bc turned-on state”, the indicator lamp light source 170a is turned on, and both the indicator lamp light sources 170b and 170c are turned off. Accordingly, a display pattern in which “turning off one, turning on four, turning off one” is repeated from a left side to a right side of the drawing is obtained.

As described above, in the arrangement example and the display pattern example of the indicator lamp light sources according to the present embodiment, the number of indicator lamp light sources 170a, 170b, and 170c in the non-turned-on state is increased or decreased by two such as 4, 2, and 0 every display pattern while maintaining a set of three units. Accordingly, similarly to the third embodiment (FIG. 11) described above, the switching of the display pattern (and the change in the optical axis light reception amount) is easily recognized.

<Relationship between Optical Axis Light Reception Amount and Display Pattern>

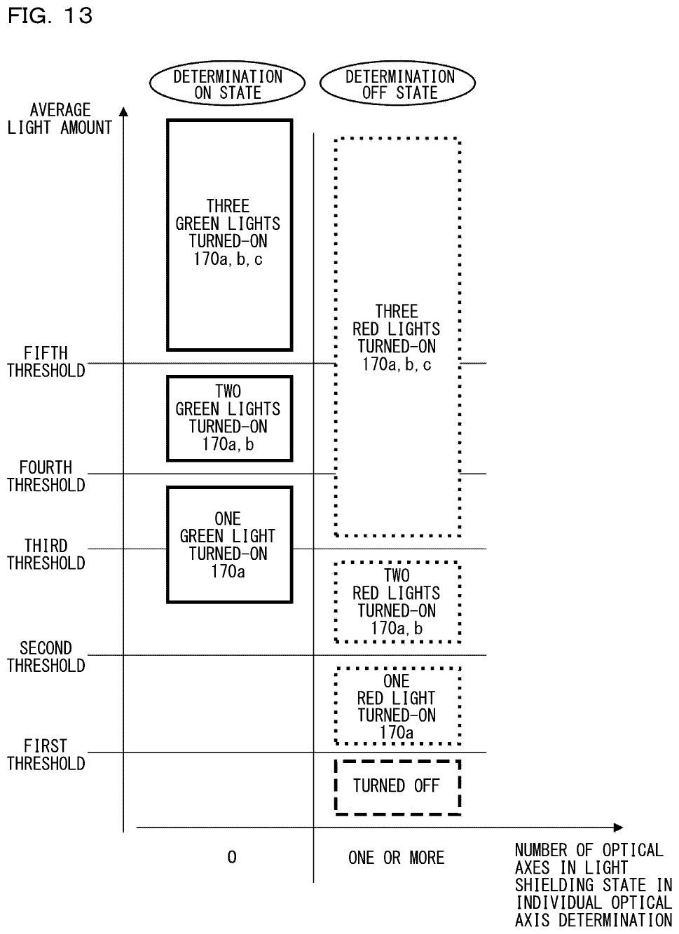

FIG. 13 is a diagram illustrating a relationship between the optical axis light reception amount (average light reception amount) and the display pattern. The optical axis light reception amount is converted by an A/D converter and is compared with a threshold. A determination criterion for determining the display pattern may be an average value (=average light reception amount) of the light reception amounts on the optical axes.

First, an ON state of the OSSD indicates a state where a condition that “the light reception amounts of all the optical axes are a first threshold or more” is satisfied for the light receiving elements 261 to 266, and the OSSD output is ON. In the present embodiment, for the sake of convenience, a state where the light receiving elements 261 to 266 satisfies the condition and the OSSD output can be turned on is set as a determination ON state, and the determination ON state is a state where “the light reception amounts of all the optical axes are the first threshold or more”. The first threshold is identical to a threshold for determining whether or not each individual optical axis is in the light shielding state. Thus, the average light reception amount in this state is high to some extent, and cannot be a value low enough to be considered as “complete light shielding”. That is, since the light reception amounts of all the optical axes are the first threshold or more, the average light reception amount cannot fall below the first threshold.

Accordingly, “OFF” display when the average light reception amount falls below the first threshold can be understood as a display aspect in which the light receiving elements 261 to 266 do not satisfy the condition that “the light reception amounts of all the optical axes are the first threshold or more”, that is, which is only in a determination OFF state. In this drawing, a horizontal axis is introduced to clarify this display aspect. The horizontal axis indicates a result of individual light reception amount determination for each optical axis (=the number of optical axes determined to be in the light shielding state by individual optical axis determination). Note that, an OFF state of the OSSD indicates a state where the condition that “the light reception amounts of all the optical axes are the first threshold or more” is not satisfied for the light receiving elements 261 to 266 and the OSSD output is OFF. In the present embodiment, for the sake of convenience, a state where the light receiving elements 261 to 266 do not satisfy the condition that “the light reception amounts of all the optical axes are the first threshold or more”, that is, a state where “the light reception amounts of at least one or more optical axes are less than the first threshold” is regarded as the determination OFF state. That is, in the determination ON state, the number of optical axes in the light shielding state is 0. On the other hand, in the determination OFF state, the number of optical axes in the light shielding state is 1 or more.

Note that, the individual light reception amount determination for each optical axis is performed only in the determination ON state (display color: green) and the determination OFF state (display color: red). Thus, a step of performing this determination on a flowchart to be described later is the same step as a step of comparing the average light reception amount with the threshold.

In addition, in the determination ON state and the determination OFF state, a threshold as a determination criterion for switching the number of turned-on indicator lamp light sources 170a, 170b, and 170c is shifted. First, the determination ON state will be described. As described above, the determination ON state is a state where the light reception amounts of all the optical axes are the first threshold or more. Thus, in the determination ON state, thresholds for switching the number of turned-on indicator lamp light sources (a fourth threshold and a fifth threshold in this drawing) are provided in a region where the average light reception amount is relatively high.

With reference to this drawing, when the average light reception amount is lower than the fourth threshold in the determination ON state, one green light is turned on (=a state where only the indicator lamp light source 170a is turned on in green). When the average light reception amount is higher than the fourth threshold and lower than the fifth threshold, two green lights are turned on (=a state where the indicator lamp light sources 170a and 170b are turned on in green). When the average light reception amount is higher than the fifth threshold, three green lights are turned on (=a state where the indicator lamp light sources 170a, 170b, and 170c are turned on in green). That is, as the average light reception amount increases, the number of turned-on green lights increases.

Note that, as the distance between the light projector 100 and the light receiver 200 increases, the light reception amount of each optical axis decreases. Although the light projector 100 and the light receiver 200 are provided in parallel and can normally receive light without contamination, it is also conceivable that the light reception amount decreases only due to an increase in the distance between the light projector 100 and the light receiver 200.

When the number of turned-on indicator lamp light sources 170a, 170b, and 170c is reduced in such a situation, information regarding installation and maintenance cannot be correctly transmitted. Thus, it is desirable to set the threshold so as to widen a region where the number of turned-on indicator lamp light sources 170a, 170b, and 170c is 3. With reference to this drawing, in the determination ON state, the fifth threshold for switching the number of turned-on indicator lamp light sources 170a, 170b, and 170c between three and two is set to be relatively low.

Next, the determination OFF state will be described. Switching control of the display pattern in the determination OFF state is useful when the light projector 100 and the light receiver 200 are installed. For example, a case where installation positions of the light projectors 100 and 200 are adjusted starting from the turned-off state where the number of turned-on indicator lamp light sources is 0 will be considered. In this case, in order to grasp directionality of the adjustment (=whether or not the installation positions are close to correct installation positions), it is desirable that the display pattern is switched even though the average light reception amount slightly increases or decreases.

Thus, in the determination OFF state, the thresholds (the first threshold, the second threshold, and the third threshold in this drawing) for switching the number of turned-on indicator lamp light sources are provided in a region where the average light reception amount is relatively low. For example, a relationship between the thresholds may be first threshold<second threshold<third threshold<fourth threshold<fifth threshold as illustrated in this drawing. In the embodiment illustrated in this drawing, all of the first threshold, the second threshold, and the third threshold do not influence the switching of the number of turned-on indicator lamp light sources in the ON state.

With reference to this drawing, when the average light reception amount is lower than the first threshold in the determination OFF state, the state becomes the turned-off state (=a state where the indicator lamp light sources 170a, 170b, and 170c are turned off) as described above. When the average light reception amount is higher than the first threshold and lower than the second threshold, one red light is turned on (=a state where only the indicator lamp light source 170a is turned on in red). When the average light reception amount is higher than the second threshold and lower than the third threshold, two red lights are turned on (=a state where the indicator lamp light sources 170a and 170b are turned on in red). When the average light reception amount is higher than the third threshold, three red lights are turned on (=a state where the indicator lamp light sources 170a, 170b, and 170c are turned on in red). That is, as the average light reception amount increases, the number of turned-on red lights increases.

As described above, in the determination ON state and the determination OFF state, the purpose of switching the display pattern is different in accordance with the optical axis light reception amount. Specifically, it is assumed that the display pattern switching in the turned-on green light in the determination ON state is useful for grasping dirt adhesion (necessity of maintenance) after the start of an operation of the light curtain 1. On the other hand, it is assumed that the display pattern switching in red light in the determination OFF state is useful for optical axis adjustment when the light curtain 1 is installed. Thus, in order to individually set optimal thresholds for the determination ON state and the determination OFF state, it is desirable to shift the thresholds between the determination ON state and the determination OFF state.

However, contrary to the above description, it is also advantageous to match the thresholds between the determination ON state and the determination OFF state. For example, in this drawing, from the viewpoints of only the average light reception amount, “one green light is turned on” in the determination ON state and “three red lights are turned on (or two red lights are turned on)” in the determination OFF state are adjacent to each other. Thus, when the optical axis is shielded and the determination ON state is switched to the determination OFF state while the average light reception amount is maintained, the display pattern is switched from “one green light is turned on” to “three red lights are turned on (or two with red lights turned on)”.

That is, focusing only on the number of turned-on lights, there is a possibility that the display pattern is switched with a sense of discomfort that the number of turned-on lights increases even though the optical axis is shielded. Thus, when a priority is given to the purpose of transmitting the optical axis light reception amount in an easily understandable manner, it can be said that it is desirable to align the thresholds between the determination ON state and the determination OFF state such that a reverse rotation phenomenon of the number of turned-on lights does not occur.

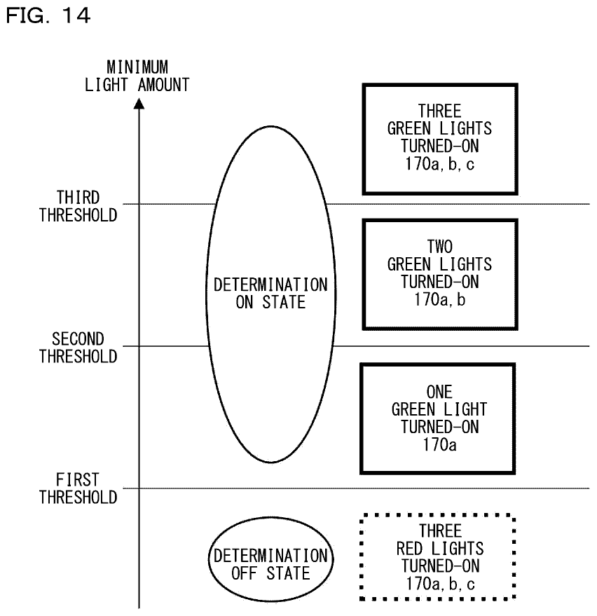

FIG. 14 is a diagram illustrating a relationship between the optical axis light reception amount (minimum light amount) and the display pattern. As illustrated in this drawing, the determination criterion for determining the display pattern may be a minimum value (=minimum light amount) of the light reception amount on each optical axis.

In this case, for example, a first threshold, a second threshold, and a third threshold are set as threshold setting. A relationship between the thresholds may be first threshold<second threshold<third threshold.

With reference to this drawing, when the minimum light amount is lower than the first threshold, three red lights are turned on (=a state where the indicator lamp light sources 170a, 170b, and 170c are turned on in red). This state corresponds to the determination OFF state. As described above, in the determination OFF state, the number of turned-on red lights is fixed to three. When the minimum light amount is higher than the first threshold and lower than the second threshold, one green light is turned on (=a state where only the indicator lamp light source 170a is turned on in green). When the minimum light amount is higher than the second threshold and lower than the third threshold, two green lights are turned on (=a state where the indicator lamp light sources 170a and 170b are turned on in green). When the minimum light amount is higher than the third threshold, three green lights are turned on (=a state where the indicator lamp light sources 170a, 170b, and 170c are turned on in green). That is, as the minimum light amount increases, the number of turned-on green lights increases.

As described above, as the determination criterion for determining the display pattern, an average value (=average light reception amount) of the light reception amounts in the optical axes may be adopted, or the minimum value (=minimum light reception amount) may be adopted.

### <Turned-on Image>

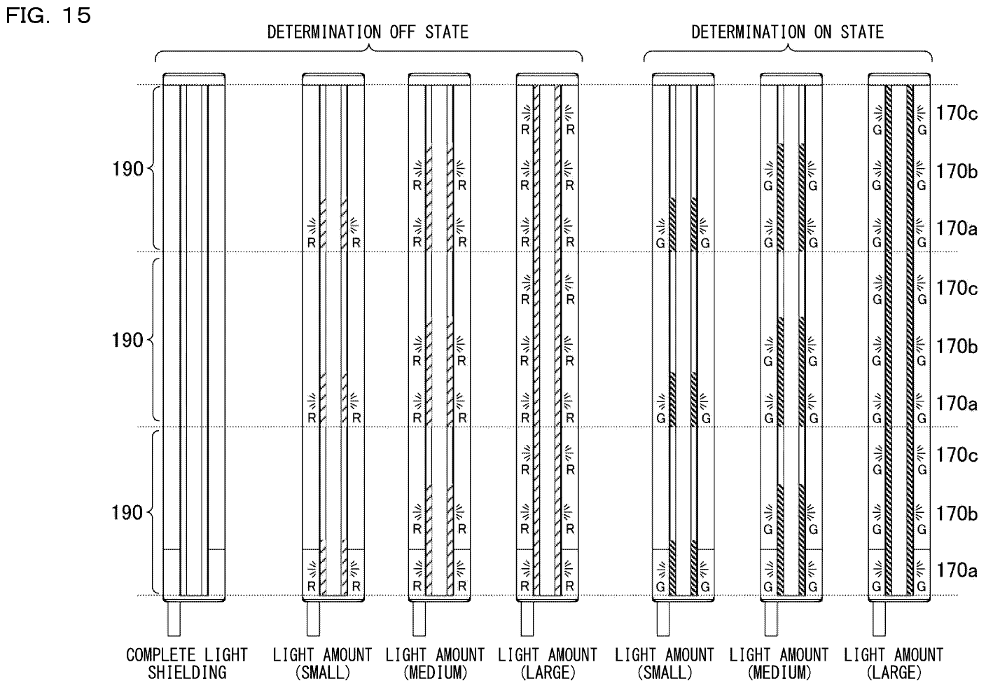

FIG. 15 is a diagram illustrating a turned-on image (first example) of the light curtain 1. In this drawing, the second embodiment described above (FIGS. 9 and 10) is adopted as the arrangement example and the display pattern of the indicator lamp light sources 170a, 170b, and 170c. In addition, for the relationship between the optical axis light reception amount and the display pattern, the switching control of the display pattern described above with reference to FIG. 13 is adopted.

First, the determination OFF state (four states on a left side of this drawing) will be described. In a complete light shielding state, the light curtain 1 is turned off (=a state where the indicator lamp light sources 170a, 170b, and 170c are turned off). In light amount (small), one red light is turned on (=a state where only the indicator lamp light source 170a is turned on in red). In light amount (medium), two red lights are turned on (=a state where the indicator lamp light sources 170a and 170b are turned on in red). In light amount (large), three red lights are turned on (=a state where the indicator lamp light sources 170a, 170b, and 170c are turned on in red).

Next, the determination ON state (three states on a right side of this drawing) will be described. In light amount (small), one green light is turned on (=a state where only the indicator lamp light source 170a is turned on in green). In light amount (medium), two green lights are turned on (=a state where the indicator lamp light sources 170a and 170b are turned on in green). In light amount (large), three green lights are turned on (=a state where the indicator lamp light sources 170a, 170b, and 170c are turned on in green).

Note that, a light diffusing body is arranged above each of the indicator lamp light sources 170a, 170b, and 170c. Thus, it is desirable to appropriately set the arrangement and the display pattern of the indicator lamp light sources 170a, 170b, and 170c such that switching of the display pattern can be recognized also through the light diffusing body. This point is also as described above.

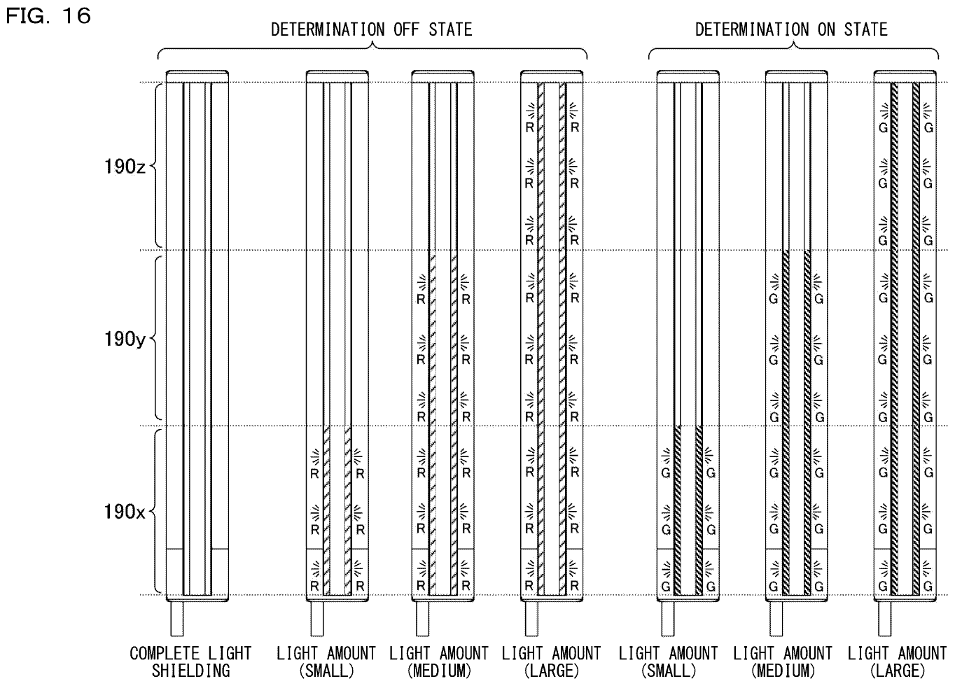

FIG. 16 is a diagram illustrating a turned-on image (second example) of the light curtain 1. In this drawing, bar display of the light curtain 1 corresponding to the optical axis light reception amount is performed. Specifically, each of three substrates 190x, 190y, and 190z cascade-connected in the longitudinal direction of the light curtain 1 (more precisely, a group of indicator lamp light sources 170 incorporated therein) is controlled to be turned on or off as an individual unit.

First, the determination OFF state (four states on a left side of this drawing) will be described. In a complete light shielding state, the light curtain 1 is turned off (=a state where the substrates 190x, 190y, and 190z are turned off). In light amount (small), 1/3 of the light curtain 1 is turned on with a red bar (=only the substrate 190x is turned on in red). In light amount (medium), 2/3 of the light curtain 1 is turned on with a red bar (=a state where the substrates 190x and 190y are turned on in red). In light amount (large), the entire light curtain 1 (3/3) is turned on with a red bar (=a state where the substrates 190x, 190y, and 190z are turned on in red).

Next, the determination ON state (three states on a right side of this drawing) will be described. In light amount (small), 1/3 of the light curtain 1 is turned on with a green bar (=only the substrate 190x is turned on in green). In light amount (medium), 2/3 of the light curtain 1 is turned on with a green bar (=the substrates 190x and 190y are turned on in green). In light amount (large), the entire light curtain 1 (3/3) is turned on with a green bar (=a state where the substrates 190x, 190y, and 190z are turned on in green).

As described above, in the turned-on image of the second example (FIG. 16), the switching of the display pattern corresponding to the optical axis light reception amount is more easily grasped as compared with the above-described first example (FIG. 15). Note that, in a case where the above-described turned-on image is realized based on the configuration in which the plurality of substrates 190x, 190y, and 190z are cascade-connected, a design difficulty level and cost can increase.

<Modification of Display Pattern corresponding to Optical Axis Light Reception Amount>

In the above description, the configuration in which the number (in particular, an intermittent interval) of turned-on indicator lamp light sources 170 is switched in accordance with the optical axis light reception amount has been illustrated. However, other various modifications are conceivable.

For example, a temporal change (for example, whether or not to constantly turn on the indicator lamp 140, blink the indicator lamp at intervals of 1 second, or blink the indicator lamp at intervals of 2 seconds) of the indicator lamp 140 may be switched in accordance with the optical axis light reception amount. In addition, for example, a light emission amount or a light emission color of the indicator lamp 140 may be switched in accordance with the optical axis light reception amount. In a case where these aspects are adopted, it is not necessary to individually control the plurality of indicator lamp light sources 170 at the time of switching the display pattern. Thus, for example, an optical guiding fiber can be used as the indicator lamp 140.

<Functional Block (having Display Pattern Control Function)>

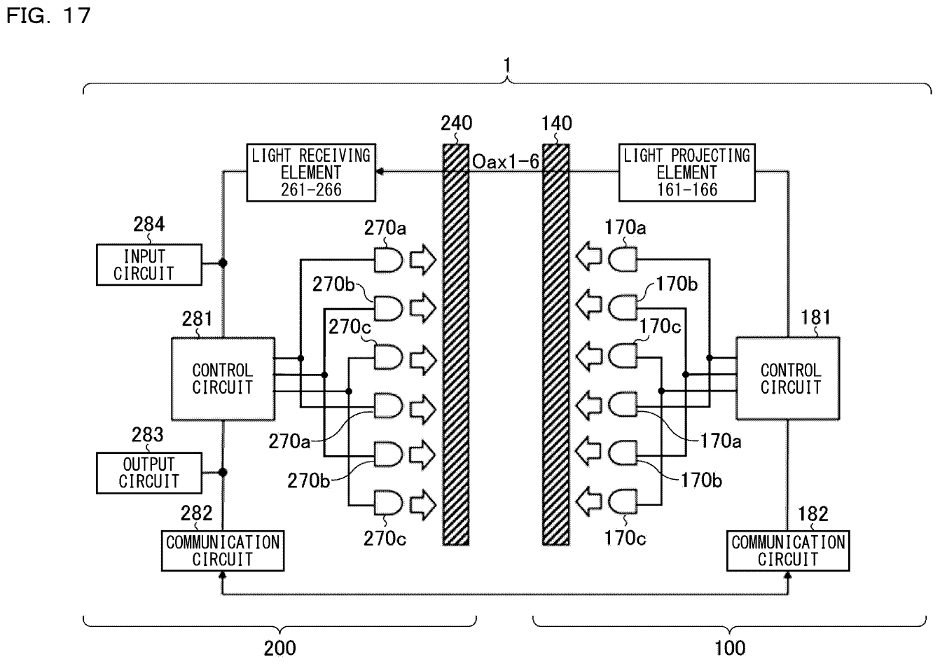

FIG. 17 is a functional block diagram of the light curtain 1 having a display pattern control function. Note that, in this drawing, with reference to FIG. 5 described above, control systems of the indicator lamp light sources 170a, 170b, and 170c and the indicator lamp light sources 270a, 270b, and 270c are focused instead of light emission and light reception systems of the optical axes Oax1 to Oax6.

In addition, according to the second embodiment (FIGS. 9 and 10) described above, the indicator lamp light sources 170a, 170b, and 170c, and the indicator lamp light sources 270a, 270b, and 270c are arrayed as a set of three in the illustrated order (in the order of a, b, c, a, b, and c from the upper side of this drawing).

The control circuit 181 controls the two indicator lamp light sources 170a by a common control signal. The same applies to the indicator lamp light sources 170b and 170c. In addition, the control circuit 281 controls the two indicator lamp light sources 270a by a common control signal. The same applies to the indicator lamp light sources 270b and 270c.

Note that, the light reception amount of each of the optical axes Oax1 to Oax6 is compared with the threshold in the control circuit 281. In this case, the control circuit 281 may include an analog-to-digital conversion circuit that converts an analog signal output from each of the light receiving elements 261 to 266 into a digital signal. In addition, the control circuit 281 may include an arithmetic circuit that calculates an average value (=average light reception amount) or a minimum value (=minimum light reception amount) from the light reception amount of each of the optical axes Oax1 to Oax6.

The control circuit 281 performs turned-on or turned-off control of each of the indicator lamp light sources 270a, 270b, and 270c based on a comparison result between the average light reception amount (or the minimum light reception amount) and the threshold. In addition, the control circuit 281 transmits the comparison result to the control circuit 181 via the communication circuits 282 and 182. The control circuit 181 performs turned-on or turned-off control of each of the indicator lamp light sources 170a, 170b, and 170c based on the comparison result transmitted from the control circuit 281.

### <Processing Flow>

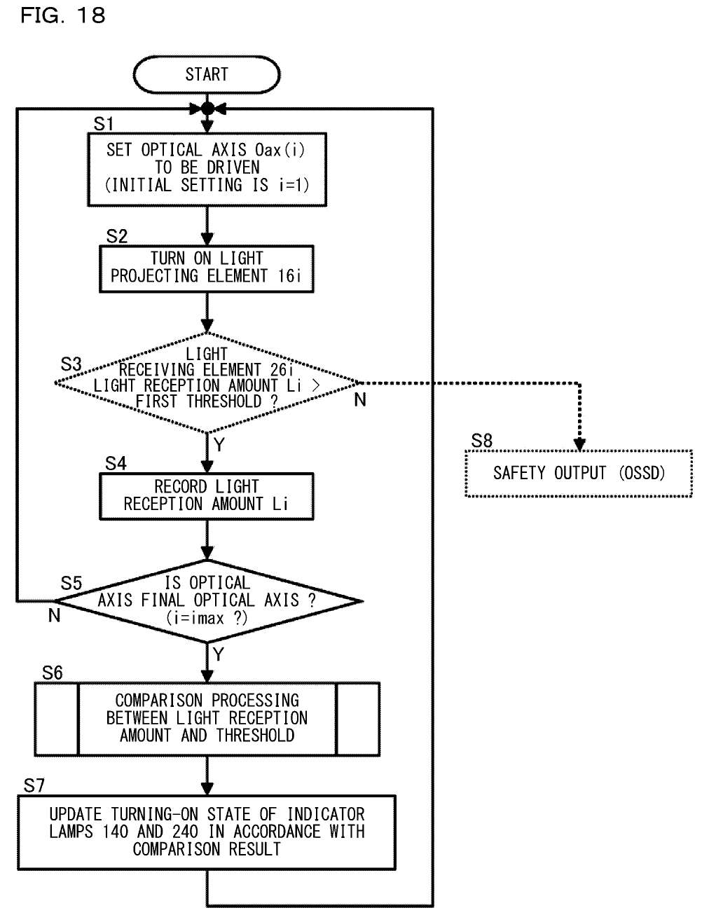

FIG. 18 is a diagram illustrating a processing flow of display pattern control based on the average light reception amount. When the processing flow of this drawing is started, in step S1, the optical axis Oax(i) (where i=1, 2, . . . , and imax(6) and an initial setting value is i=1) to be driven is set.

In subsequent step S2, the light projecting element 16i is turned on. That is, first, the light projecting element 161 for forming the optical axis Oax1 is turned on.

In step S3, it is determined whether or not a light reception amount Li in the light receiving element 26i is larger than the first threshold. Note that, as described above, the first threshold corresponds to the threshold for determining whether or not each of the optical axes Oax1 to Oax6 is in the light shielding state. Here, in a case where YES determination is made, the flow proceeds to step S4. On the other hand, in a case where NO determination is made, the flow proceeds to step S8. In step S8, the safety output (OSSD) is switched to the OFF state without waiting for completion of the display pattern control. Accordingly, it is possible to promptly stop a dangerous source such as a press machine. In addition, in step S8, in addition to the safety output (OSSD) being switched to the OFF state, the display aspect of the OSSD indicator lamp may be changed in accordance with the safety output (OSSD) being switched to the OFF state. Note that, steps S3 and S8 are not directly related to the display pattern control. Thus, steps S3 and S8 are depicted by broken lines in this drawing.

When YES determination is made in step S3, the light reception amount Li is recorded in a register or the like in step S4.

In subsequent step S5, it is determined whether or not the optical axis is the final optical axis (that is, i=imax(6)). Here, in a case where YES determination is made, the flow proceeds to step S6. On the other hand, in a case where NO determination is made, the flow returns to step S1 after a variable i is incremented by one (++i). Thereafter, steps S1 to S5 are repeated until YES determination is made in step S5.

When YES determination is made in step S5, in step S6, comparison processing between the average value (=average light reception amount) or the minimum value (=minimum light reception amount) of the light reception amounts and the plurality of thresholds is performed. The comparison processing in this step has been described with reference to FIGS. 13 and 14 described above. Thus, the redundant description is omitted.

In subsequent step S7, the turned-on state (display pattern) of each of the indicator lamps 140 and 240 is updated in accordance with the comparison result obtained in step S6. Thereafter, the flow returns to step S1, and the series of processing is repeated.

Note that, this drawing is drawn with the fact that in step S6, comparison processing between the average value (=average light reception) of the light reception amounts and the plurality of thresholds can be performed in mind. That is, the comparison processing in step S6 is not performed for each optical axis, but is performed after the light reception amounts of all the optical axes are recorded.

However, in a case where the comparison processing between the minimum value (=minimum light reception amount) of the light reception amount and the plurality of thresholds is performed, step S5 may be omitted. That is, the comparison processing in step S6 may be sequentially performed for each optical axis at a time without waiting for the light reception amounts of all the optical axes to be recorded.

For example, when the light reception amount obtained by the first light receiving element 261 is the second threshold or less, it is sufficient to switch to one green light (=a state where only the indicator lamp light source 170a is turned on in green) without comparing the light reception amount of each of the other light receiving elements 262 to 266 with the threshold (see FIG. 14). Accordingly, the subsequent comparison processing can be omitted.

### SUMMARY

In FIGS. 9 to 18 described above, the light curtain 1 having the function of switching the display pattern corresponding to the optical axis light reception amount has been proposed. When this configuration is briefly described, it can be expressed as “A light curtain including a housing having a metal case in which one element of a pair of a light projecting element and a light receiving element forming a plurality of optical axes is arranged inside along a longitudinal direction and which extends in the longitudinal direction, and end members connected to both ends of the metal case, in order to form the plurality of optical axes at intervals from each other;
a cover that transmits light from the light projecting element and is attached to the housing so as to cross the plurality of optical axes;
an indicator lamp that is a light diffusing member, arranged outward from an outer surface of at least one of the cover and the housing along the longitudinal direction, or formed in series with the cover; and
an indicator lamp light source that is accommodated inside the housing and that supplies light for display toward the indicator lamp,
wherein, when an operation indicator lamp mode is set, the indicator lamp light source performs turned-on or turned-off control in a display pattern corresponding to a light emission color corresponding to an operation state of the light curtain and a light reception amount of the light receiving element”.

### <Attachment Tool (Resin Type)>

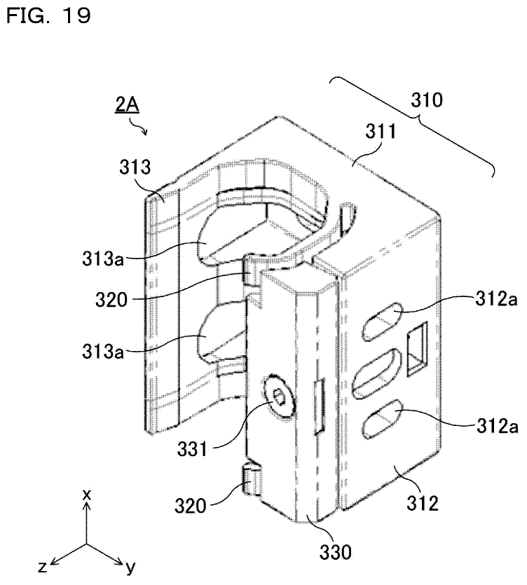

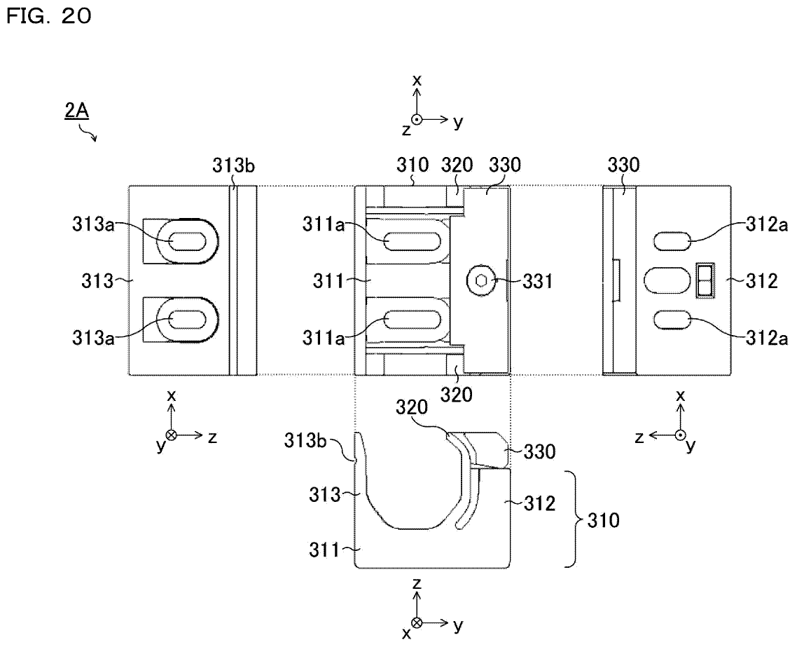

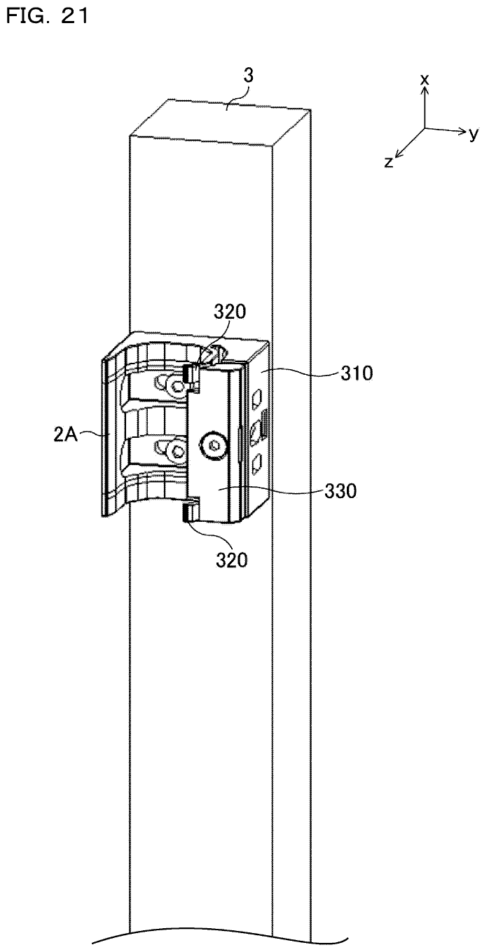

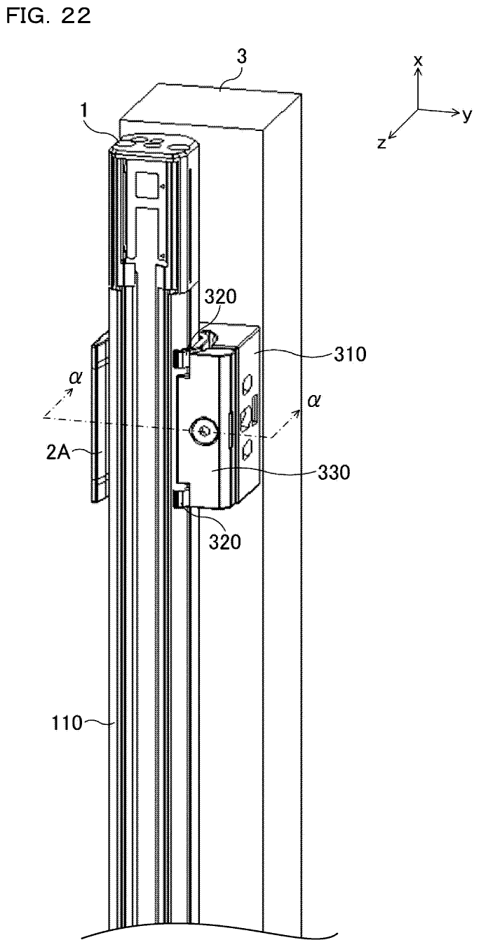

Hereinafter, a resin type attachment tool 2A will be described in detail with reference to FIGS. 19 to 22. FIGS. 19 and 20 are a perspective view and a four-view diagram, respectively, illustrating the attachment tool 2A. FIG. 21 is a diagram illustrating a scene in which the attachment tool 2A is attached to a base 3. FIG. 22 is a diagram illustrating a scene in which the housing 110 of the light projector 100 forming the light curtain 1 is attached to the attachment tool 2A. In each drawing, the longitudinal direction of the light curtain 1 is an x-axis, a lateral direction is a y-axis, and a thickness direction (depth direction) is a z-axis. Note that, in the following description, the housing 110 of the light projector 100 may be read as the housing 210 of the light receiver 200.

The attachment tool 2A corresponds to a jig for attaching the light curtain 1 to the base 3. As described above, the multiple-optical-axis photoelectric sensor including the attachment tool 2A and the light curtain 1 attached to the attachment tool 2A can be installed on the base 3.

The attachment tool 2A includes, as main components, a base portion 310, temporary fixing portions 320, and a full fixing portion 330.

The base portion 310 is a resin member having a rear surface or a side surface attached to the base 3 and receiving the housing 110 from a front side. The base portion 310 includes a bottom portion 311 and upright portions 312 and 313. The bottom portion 311 can be formed in a rectangular shape in xy plan view. The upright portions 312 and 313 may be raised in a z-axis direction from both end positions of the bottom portion 311 in a y-axis direction. The base portion 310 can be formed in, for example, a substantially U shape with a front opening in yz plan view.

A through-hole 311a through which a screw passes in the z-axis direction is provided in the bottom portion 311. In addition, a through-hole 312a through which the screw passes in the y-axis direction is provided in the upright portion 312. The base portion 310 is screwed to the base 3 through the through-hole 311a or 312a. That is, the rear surface or the side surface of the base portion 310 attached to the base 3 can be understood as an outer side surface of each of the bottom portion 311 or the upright portion 312. Each of the through-holes 311a and 312a can be formed in a shape in which a screwing position can be voluntarily adjusted. For example, the through-hole 311a may be formed in an oval shape of which a longitudinal direction is the y-axis direction in xy plan view. In addition, the through-hole 312a may be formed in an oval shape of which a longitudinal direction is the z-axis direction in xz plan view. Note that, a plurality of through-holes 311a and a plurality of through-holes 312a may be provided.

A through-hole 313a into which a tool such as a hexagonal wrench is inserted in the y-axis direction may be provided in the upright portion 313. The through-hole 313a may be provided at a position facing the through-hole 312a. The through-hole 313a may be larger than the through-hole 312a. With this configuration, it is possible to easily perform a work of screwing the base portion 310 to the base 3 through the through-hole 312a.

A groove 313b parallel to an x-axis direction, that is, the longitudinal direction of the light curtain 1 may be provided on the outer side surface of the upright portion 313. The technical significance will be described later.

The temporary fixing portions 320 are members that temporarily fix the housing 110 to the base portion 310 by elastic support. The base portion 310 and the temporary fixing portions 320 may be integrally molded resin members. The temporary fixing portions 320 may be provided at both end positions of the bottom portion 311 in the x-axis direction. The temporary fixing portions 320 can be a finger-shaped leaf spring bent along an outer shape of the housing 110 so as to be able to support the housing 110 at least at three points together with the base portion 310.

The full fixing portion 330 is a member that fixes a rotational position of the housing 110 around an axis and an upper-lower position in the longitudinal direction by pressing the housing 110 and the temporary fixing portions 320 inward in a state where the housing 110 is temporarily fixed to the base portion 310. The full fixing portion 330 may be a metal member independent of the base portion 310 and the temporary fixing portions 320.

The full fixing portion 330 is screwed to a front end of the upright portion 312 by a screw 331 extending in the z-axis direction. When the screw 331 is loosened, the rotational position and the upper-lower position of the housing 110 can be adjusted. On the other hand, when the screw 331 is tightened, the rotational position and the upper-lower position of the housing 110 are fixed. The upright portion 312 functions as a receiving member of the screw 331. Accordingly, a wall thickness of the upright portion 312 in the y-axis direction is designed to be larger than a wall thickness of the upright portion 313 in the y-axis direction.

### <Attachment Work (Outline)>

Next, an outline of an attachment work of the light curtain 1 using the attachment tool 2A will be described. First, in a first step, as illustrated in FIG. 21 described above, the attachment tool 2A is screwed to the base 3. Subsequently, in a second step, as illustrated in FIG. 22 described above, the housing 110 is temporarily fixed to the base portion 310 of the attachment tool 2A. Finally, in a third step, after the rotational position of the housing 110 around the axis and the upper-lower position in the longitudinal direction are adjusted, the housing 110 is fully fixed to the base portion 310 of the attachment tool 2A.

### <Housing (Metal Case)>

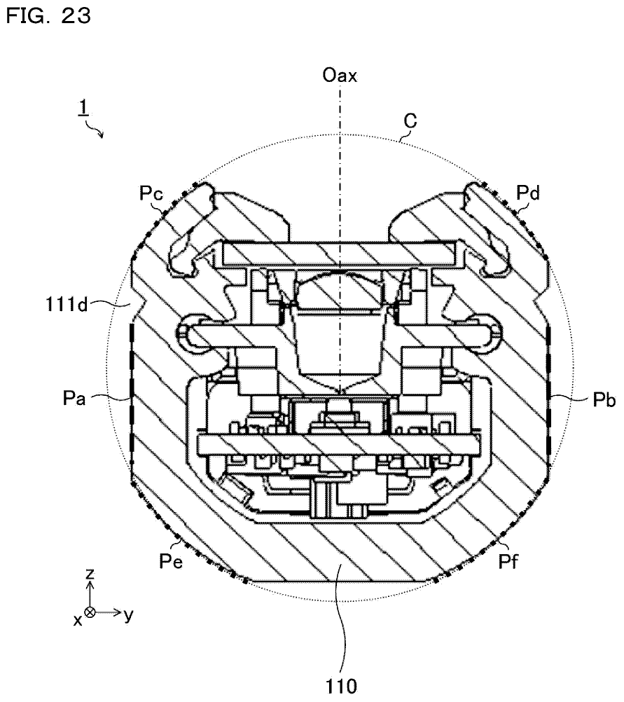

FIG. 23 is a sectional view illustrating the outer shape of the housing 110 (particularly the metal case 111). Note that, in this drawing, a section when the housing 110 is vertically cut at any position in the longitudinal direction, that is, a zy section orthogonal to the longitudinal direction is drawn. As illustrated in this drawing, the housing 110 includes side wall portions Pa and Pb and arc portions Pc to Pf.

The side wall portions Pa and Pb are substantially parallel to the optical axis Oax in zy sectional view of the housing 110. The side wall portions Pa and Pb are provided so as to be line-symmetric with each other with respect to the optical axis Oax. Each of the arc portions Pc to Pf becomes a part of a circumference C in zy sectional view of the housing 110. The arc portions Pc and Pd are provided so as to be line-symmetric with each other with respect to the optical axis Oax. The arc portions Pe and Pf are provided so as to be line-symmetric with respect to the optical axis Oax. The arc portions Pc and Pd are provided in front of the side wall portions Pa and Pb, that is, on a front surface side of the housing 110. The arc portions Pe and Pf are provided behind the side wall portions Pa and Pb, respectively, that is, on a rear surface side of the housing 110.

In the housing 110 of the present configuration example, the housing is attached so as to be directly gripped by the attachment tool 2A. Accordingly, it is not necessary to form a fitting attachment groove on a rear surface of the housing 110. Note that, in a general configuration in which the fitting attachment groove is formed in the housing 110, it is necessary to increase strength of a rear surface portion where the fitting attachment groove is formed, and the size of the housing 110 is increased. On the other hand, in the housing 110 of the present configuration example, since there is no restriction on the strength of the rear surface portion, the size of the housing 110 can be reduced.

In addition, as described above, the housing 110 of the present configuration example includes the arc portions Pc to Pf. Accordingly, the housing 110 is rotated around the x-axis in a state where the housing 110 is temporarily fixed to the attachment tool 2A, and thus, the rotational position of the housing 110 can be voluntarily adjusted. The attachment work of the housing 110 will be described in detail later.

Note that, a groove 111d parallel to the x-axis direction, that is, the longitudinal direction of the housing 110 may be provided on the outer side surface of the housing 110. The technical significance will be described later.

### <Attachment Work (Details)>

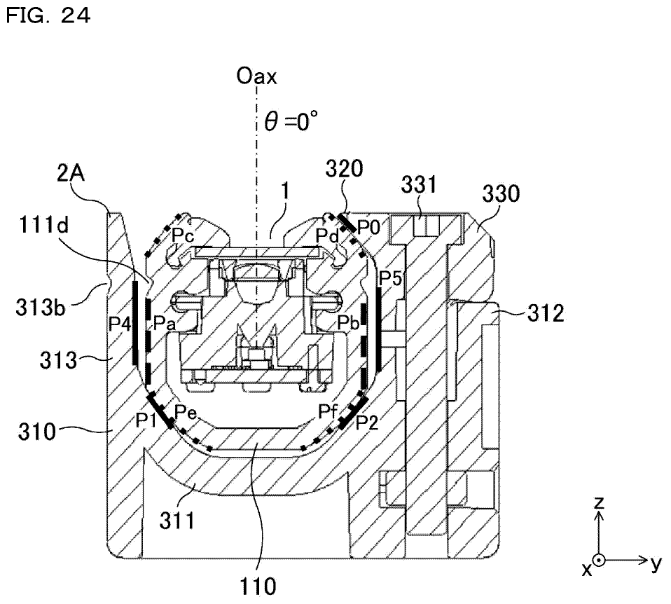

FIG. 24 is a sectional view illustrating a scene in which the housing 110 is attached to the attachment tool 2A with the front face facing. This drawing can be understood as an a-a section in FIG. 22 described above.

First, a temporary fixing work of the housing 110 will be described. The base portion 310 and the temporary fixing portions 320 support the housing 110 at least at three points. For example, in a case where the attachment tool 2A is attached to the housing 110 in a state where the optical axis Oax is parallel to the z-axis, that is, in a state where the housing 110 faces the front, inner side surfaces of the bottom portion 311 in the base portion 310 can be supports P1 and P2. With reference to this drawing, the support P1 abuts on the arc portion Pe, and the support P2 abuts on the arc portion Pf. In addition, an inner side surface of a finger tip in the temporary fixing portion 320 can be an elastic support P0. With reference to this drawing, the elastic support P0 abuts on the arc portion Pd.

The elastic support P0 elastically supports the housing 110 by biasing the arc portion Pf inward. Thus, a fixing force of the housing 110, that is, a normal force acting between the elastic support P0 and the arc portion Pd is lower than in a case where the temporary fixing portion 320 does not have spring properties. Accordingly, the housing 110 is temporarily fixed in a state where the rotational position of the housing 110 around the axis and the upper-lower position in the longitudinal direction can be adjusted by a frictional force acting between the elastic support P0 and the arc portion Pd. That is, the housing 110 can be temporarily fixed without requiring screw fastening only by being fitted into the attachment tool 2A.

In addition, the base portion 310 includes rotation restricting portions P4 and P5. Each of the rotation restricting portions P4 and P5 is formed by an inner side surface parallel to the x-axis direction, that is, an inner side surface parallel to a front-rear direction of the base portion 310, among the inner side surfaces of the base portion 310 facing the housing 110. With reference to this drawing, the rotation restricting portions P4 and P5 can be formed by inner side surfaces of the upright portions 312 and 313, respectively. As described above, the rotation restricting portions P4 and P5 may be provided on both sides of a space for receiving the housing 110 so as to face the side wall portions Pa and Pb of the housing 110.

The rotation restricting portion P4 or P5 limits a rotation angle θ of the housing 110 around the x-axis to a predetermined restricting range, for example, −θlim≤θ<+θlim by abutting on the side wall portion Pa or Pb of the housing 110 in a state where the housing 110 is temporarily fixed to the base portion 310.

However, when the restricting range of the rotation angle θ is too narrow, the optical axis adjustment can be insufficient. On the other hand, when the restricting range of the rotation angle θ is too wide, workability of optical axis adjustment can be deteriorated. In view of such a trade-off, the restricting range of the rotation angle θ may be set within ±300 (−30°≤θ≤+30°), for example. More suitably, the restricting range may be within ±20° (−20°≤θ≤+20°). More desirably, the restricting range is within ±10° (−10°≤θ≤+10°).

Note that, in a case where the rotation angle θ falls within the restricting range, for example, in a case where θ=0° as illustrated in this drawing, the rotation restricting portions P4 and P5 do not abut on the side wall portions Pa and Pb of the housing 110. Such a state can be understood as a state where the rotation angle θ is not restricted.

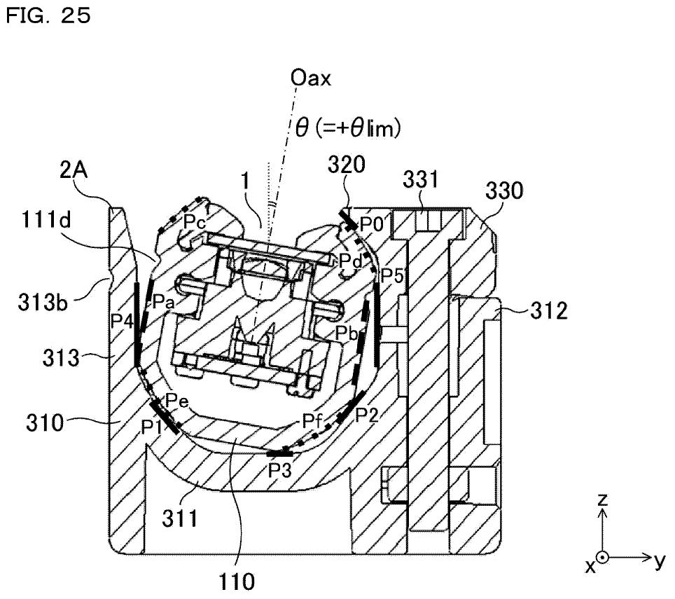

FIG. 25 is a sectional view illustrating a scene in which the rotation of the housing 110 is restricted. As illustrated in this drawing, in a state where the housing 110 is rotated clockwise around the x-axis by a rotation angle θlim, that is, in a state where θ=+θlim, the rotation restricting portion P4 abuts on the side wall portion Pa. As a result, the housing 110 cannot further rotate clockwise. In this state, the arc portion Pf of the housing 110 can abut not only the support P2 of the base portion 310 but also the support P3. That is, the base portion 310 and the temporary fixing portions 320 support the housing 110 at five points of the supports P1 to P3, the rotation restricting portion P4, and the elastic support P0.

In addition, although not illustrated again, in a state where the housing 110 is rotated counterclockwise around the x-axis by the rotation angle θlim, that is, in a state where θ=−θlim, the rotation restricting portion P5 abuts on the side wall portion Pb of the housing 110. As a result, the housing 110 cannot further rotate counterclockwise.

Note that, as illustrated in FIGS. 24 and 25, the grooves 111d and 313b parallel to the longitudinal direction of the light curtain 1 are provided on the outer side surface of the housing 110 and the outer side surface of the upright portion 313, respectively. These grooves 111d and 313b can serve as marks for identifying whether or not the housing 110 is attached to the attachment tool 2A in a state of facing the front.

For example, as illustrated in FIG. 24, the worker who performs the attachment work of the light curtain 1 can recognize at a glance that the housing 110 faces the attachment tool 2A by confirming that relative positions of the grooves 111d and 313b in the z-axis direction are matched with each other.

Subsequently, a full fixing work of the housing 110 will be described with reference to FIGS. 24 and 25. After the rotational position and the upper-lower position of the housing 110 are adjusted, the screw 331 is tightened, and thus, the full fixing portion 330 is fastened to the base portion 310. As a result, the housing 110 is supported at least at three points of the supports P1 and P2 of the base portion 310 and the full fixing portion 330 having no spring properties. With this configuration, the housing 110 can be fully fixed by one screw tightening. Accordingly, the attachment work of the light curtain 1 is facilitated as compared with the related art.

Note that, the full fixing portion 330 is desirably made of metal instead of resin. With this configuration, the full fixing portion 330 is less likely to deform at the time of full fixing by screw fastening or at the time of use at a high temperature. Accordingly, a fixing force of the housing 110 can be improved.

In addition, the temporary fixing portions 320 and the full fixing portion 330 may be designed such that pressing directions with respect to the housing 110 are identical to each other. With this configuration, the rotational position and the upper-lower position adjusted at the time of temporary fixing are less likely to be shifted at the time of full fixing.

In particular, a friction coefficient of the inner side surface of the base portion 310 is desirably larger than a friction coefficient of a surface of each of the temporary fixing portions 320 and the full fixing portion 330. More specifically, machining for increasing the friction coefficients, for example, emboss machining can be performed only on portions that can be the supports P1 to P3 and the rotation restricting portions P4 and P5 described above, that is, the inner side surfaces of the bottom portion 311 and the upright portions 312 and 313 in the base portion 310.

With this configuration, the base portion 310 and the housing 110 are less likely to slide, and the temporary fixing portions 320, the full fixing portion 330, and the housing 110 are more likely to slide. As a result, the housing 110 is less likely to rotate around the x-axis while the full fixing portion 330 is pressed against the housing 110 during the full fixing work by screw tightening. Accordingly, the rotational position adjusted at the time of temporary fixing is less likely to be shifted at the time of full fixing.

### <Attachment Tool (Metal Type)>

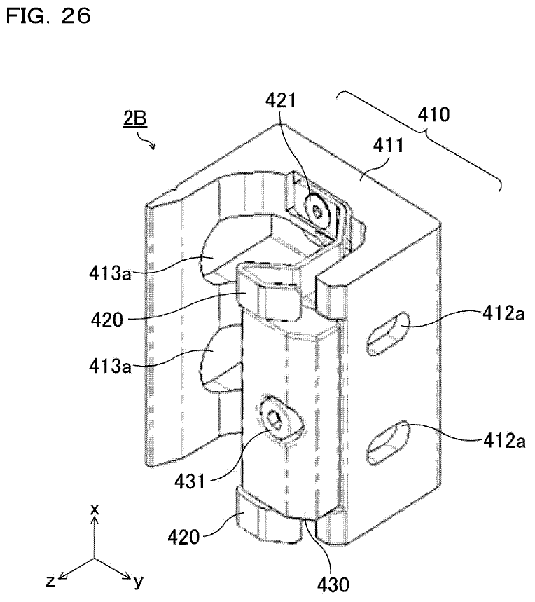

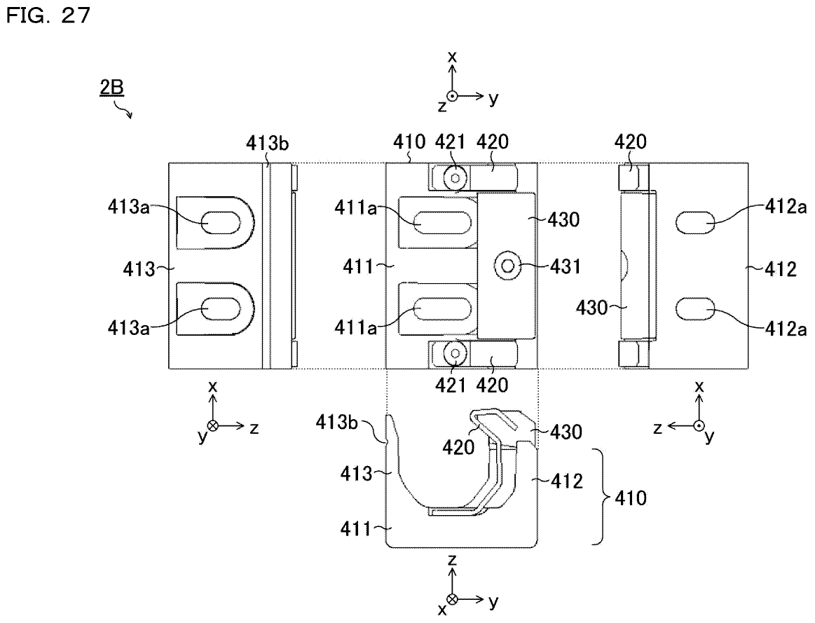

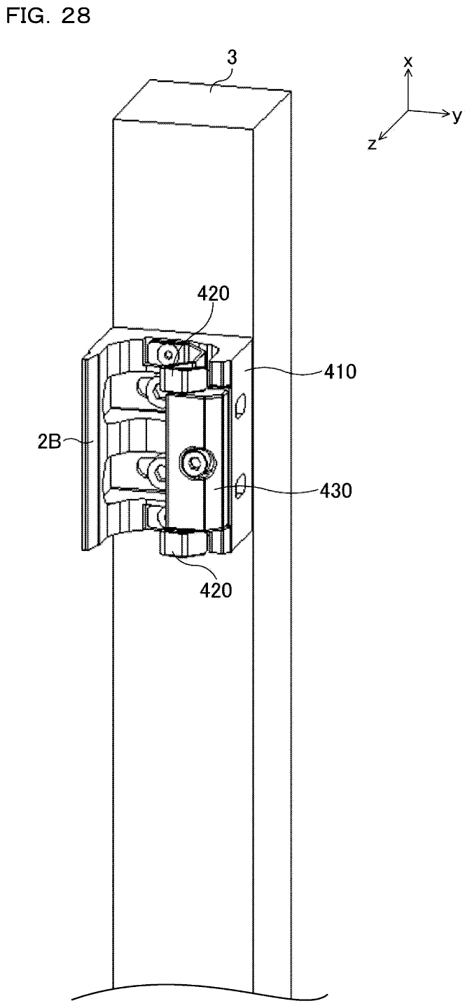

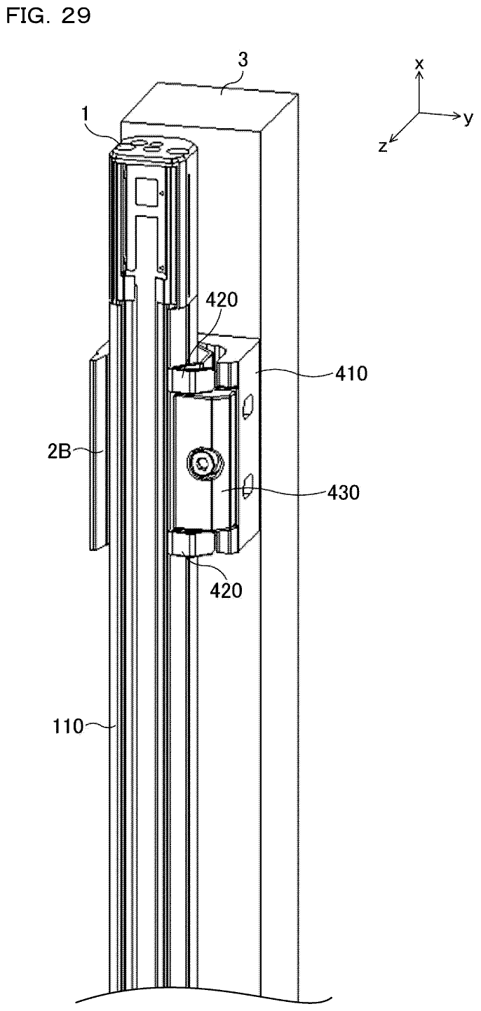

Next, a metal type attachment tool 2B will be described in detail with reference to FIGS. 26 to 29. FIGS. 26 and 27 are a perspective view and a four-view view, respectively, illustrating the attachment tool 2B. FIG. 28 is a diagram illustrating a scene in which the attachment tool 2B is attached to the base 3. FIG. 29 is a diagram illustrating a scene in which the housing 110 of the light projector 100 forming the light curtain 1 is attached to the attachment tool 2B. In each drawing, the longitudinal direction of the light curtain 1 is an x-axis, a lateral direction is a y-axis, and a thickness direction (depth direction) is a z-axis.

The attachment tool 2B includes, as main components, a base portion 410, temporary fixing portions 420, and a full fixing portion 430, similarly to the attachment tool 2A described above. Note that, the attachment tool 2B basically has a configuration similar to the attachment tool 2A. Thus, in the above description of the attachment tool 2A, reference numerals in 300 series attached to the components of the attachment tool 2A can be read as reference numerals in 400 series to be understood as the description of the attachment tool 2B. Therefore, in the following description, a characteristic configuration of the attachment tool 2B, in other words, differences from the attachment tool 2A will be mainly described.

In the attachment tool 2B, not only the full fixing portion 430 but also the base portion 410 and the temporary fixing portions 420 are made of metal. For example, the temporary fixing portions 420 may be metal springs. The metal attachment tool 2B is superior in heat resistance and impact resistance to the resin attachment tool 2A.

The base portion 410, the temporary fixing portions 420, and the full fixing portion 430 may be separate metal members. The temporary fixing portion 420 can be fixed to the base portion 410 with a screw 421. A material of the base portion may be aluminum, zinc die casting, or the like. A material of the temporary fixing portion 420 may be SUS304, phosphor bronze, or the like.

Note that, in the resin attachment tool 2A, only a bottom portion 411 of the base portion 410 and inner side surfaces of upright portions 412 and 413 may be subjected to processing for increasing friction coefficients, for example, blast processing. With this configuration, the base portion 410 and the housing 110 are less likely to slide, and the temporary fixing portions 420, the full fixing portion 430, and the housing 110 are more likely to slide. As a result, the housing 110 is less likely to rotate around the x-axis while the full fixing portion 430 is pressed against the housing 110 during the full fixing work by screw tightening. Accordingly, the rotational position adjusted at the time of temporary fixing is less likely to be shifted at the time of full fixing.

In addition, a surface of the attachment tool 2B may be subjected to coating treatment. This configuration can contribute to the prevention of damage to the housing 110.

### Other Modifications

Note that, in addition to the embodiments, various modifications can be made to various technical characteristics disclosed in the present specification without departing from the spirit of the technical creation. That is, it is to be understood that the above embodiments are illustrative in all respects and not restrictive, and the technical scope of the invention is defined by the claims, and includes all modifications falling within the meaning and scope equivalent to the claims.

What is claimed is:

1. An attachment tool for attaching a housing of a light curtain forming a plurality of optical axes along a longitudinal direction to a base,
the housing having a side wall portion substantially parallel to the optical axes in sectional view orthogonal to the longitudinal direction,
the attachment tool comprising:
a base portion having a rear surface or a side surface attached to the base and configured to receive the housing from a front side;
temporary fixing portions configured to temporarily fix the housing to the base portion by elastic support; and
a full fixing portion configured to fully fix a rotational position of the housing around an axis and an upper-lower position in the longitudinal direction by pressing the housing in a state where the housing is temporarily fixed to the base portion,
wherein the base portion includes rotation restricting portions that restrict rotation of the housing around the axis to a predetermined restricting range by abutting on the side wall portion of the housing in a state where the housing is temporarily fixed to the base portion.

2. The attachment tool according to claim 1, wherein the rotation restricting portion is formed by an inner side surface parallel to a front-rear direction of the base portion, among inner side surfaces of the base portion facing the housing, and is provided on both sides of a space for receiving the housing so as to face the side wall portion of the housing.

3. The attachment tool according to claim 1, wherein a groove parallel to the longitudinal direction is provided on an outer surface of the base portion.

4. The attachment tool according to claim 1,
wherein the housing includes arc portions that form a part of a circumference in sectional view orthogonal to the longitudinal direction, and
the base portion includes a plurality of supports that abut on the arc portions of the housing together with the temporary fixing portions.

5. The attachment tool according to claim 4, wherein a friction coefficient of each of the plurality of supports is larger than a friction coefficient of a surface of each of the temporary fixing portions and the full fixing portion.

6. The attachment tool according to claim 1, wherein pressing directions of the temporary fixing portions and the full fixing portion with respect to the housing are identical to each other.

7. The attachment tool according to claim 1, wherein the base portion and the temporary fixing portions are integrally molded resin members, and the full fixing portion is a metal member independent of the base portion and the temporary fixing portions.

8. The attachment tool according to claim 1, wherein the base portion, the temporary fixing portions, and the full fixing portion are separate metal members.

9. The attachment tool according to claim 1, wherein the restricting range is within ±30°.

10. An attachment tool for attaching, to a base, a housing of a light curtain forming a plurality of optical axes along a longitudinal direction,
the attachment tool comprising:
a base portion having a rear surface or a side surface attached to the base and configured to receive the housing from a front side;
a temporary fixing portion configured to temporarily fix the housing to the base portion by elastic support; and
a full fixing portion configured to fully fix a rotational position of the housing around an axis and an upper-lower position in the longitudinal direction by pressing the housing in a state where the housing is temporarily fixed to the base portion,
wherein the temporary fixing portion is a metal spring.

11. An attachment method for attaching the housing of the light curtain to the base by using the attachment tool according to claim 1,
the attachment method comprising:
a step of screwing the attachment tool to the base;
a step of temporarily fixing the housing to the base portion of the attachment tool; and
a step of fully fixing the housing to the base portion of the attachment tool, in the housing, a rotational position of the housing around an axis and an upper-lower position in the longitudinal direction being adjusted.

12. A multiple-optical-axis photoelectric sensor comprising:
the attachment tool according to claim 1; and
the light curtain attached to the attachment tool.
